(19) United States
(12) Patent Application Publication
(10) Pub. No.: US 2020/0304828 A1
(43) Pub. Date: Sep. 24, 2020

(54) AFFINE MOTION INHERITANCE WITH VIRTUAL PIPELINE DATA UNIT (VPDU) CONSTRAINT IN VIDEO CODING

(71) Applicant: QUALCOMM Incorporated, San Diego, CA (US)

(72) Inventors: Han Huang, San Diego, CA (US); Wei-Jung Chien, San Diego, CA (US); Marta Karczewicz, San Diego, CA (US)

(21) Appl. No.: 16/821,812

(22) Filed: Mar. 17, 2020

Related U.S. Application Data
(60) Provisional application No. 62/820,125, filed on Mar. 18, 2019.

(51) Int. Cl. H04N 19/52; H04N 19/436

(52) U.S. Cl. CPC H04N 19/52; H04N 19/436

(57) ABSTRACT

An example method includes deriving, responsive to determining to inherit affine motion information for a current block of video data located in a current virtual pipeline data unit (VPDU) from a neighboring block of video data located in a different VPDU, the affine motion information for the current block from two motion vectors of the neighboring block of video data regardless of whether the neighboring block of video data is coded with a 4-parameter affine model or a 6-parameter affine model. The example method further includes determining, based on the derived affine motion information for the current block of video data, a predictor block of video data; and reconstructing the current block of video data based on the predictor block of video data.

This application claims the benefit of U.S. Provisional Application No. 62/820,125, filed Mar. 18, 2019, the entire contents of which are incorporated by reference herein.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for inheriting affine motion parameters for a current block of video data from a neighboring block of video data. A video coder may perform affine motion parameter inheritance by determining values for one or more control point motion vectors (CPMVs) of current block based on value of one or more CPMVs of a neighboring block. Blocks coded using affine motion prediction, including the neighboring block, may have affine models that are represented by 4-parameters (e.g., having two CPMVs) or 6-parameters (e.g., having three CPMVs).

Pictures of video data may be divided into virtual pipeline data units (VPDUs) that may be successively processed by multiple pipeline stages (e.g., pipeline stages of a hardware decoder) at the same time (e.g., in parallel) such that different stages process different VPDUs simultaneously. A video coder may maintain an intra-VPDU buffer to store data from one VPDU for use in decoding other VPDUs. For instance, where values of CPMVs of the current block are predicted based on values of CPMVs of the neighboring block, a video coder may maintain a buffer to store the values of one or more of the CPMVs of the neighboring block (e.g., a line of sub-block motion vectors from a line of samples in the neighboring block that are adjacent to the current block). In some examples, it may be desirable to reduce amount of information stored in the inter-VPDU buffer.

In accordance with one or more techniques of this disclosure, a video coder may selectively constrain affine motion inheritance from a neighboring block to use either 4-parameter inheritance or 6-parameter inheritance based on whether the current block and the neighboring block are located in the same VPDU. For instance, where the current block and the neighboring block are located in the same VPDU and the neighboring block is coded using a 6-parameter affine model, the video coder may determine values for CPMVs of the current block based on values of all three CPMVs of the neighboring block (e.g., perform 6-parameter inheritance). However, where the current block and the neighboring block are located in different VPDUs and the neighboring block is coded using a 6-parameter affine model, the video coder may determine values for CPMVs of the current block based on values of two of the three CPMVs of the neighboring block (e.g., perform 4-parameter inheritance). As such, where the current block and the neighboring block are located in different VPDUs, the video coder may only need to store values for two of the three motion vectors of the neighboring block. In this way, the techniques of this disclosure enable a video coder to reduce amount of information stored in the inter-VPDU data buffer.

As one example, a method includes, responsive to determining to inherit affine motion information for a current block of video data located in a current virtual pipeline data unit (VPDU) from a neighboring block of video data located in a different VPDU, deriving the affine motion information for the current block from two motion vectors of the neighboring block of video data regardless of whether the neighboring block of video data is coded with a 4-parameter affine model or a 6-parameter affine model; determining, based on the derived affine motion information for the current block of video data, a predictor block of video data; and reconstructing the current block of video data based on the predictor block of video data.

As another example, a device includes a memory to store the video data; and one or more processors implemented in circuitry and configured to: derive, responsive to determining to inherit affine motion information for a current block of video data located in a current virtual pipeline data unit (VPDU) from a neighboring block of video data located in a different VPDU, the affine motion information for the current block from two motion vectors of the neighboring block of video data regardless of whether the neighboring block of video data is coded with a 4-parameter affine model or a 6-parameter affine model; determine, based on the derived affine motion information for the current block of video data, a predictor block of video data; and reconstruct the current block of video data based on the predictor block of video data.

As another example, a computer-readable storage medium stores instructions that, when executed, cause one or more processors to: derive, responsive to determining to inherit affine motion information for a current block of video data located in a current virtual pipeline data unit (VPDU) from a neighboring block of video data located in a different VPDU, the affine motion information for the current block from two motion vectors of the neighboring block of video data regardless of whether the neighboring block of video data is coded with a 4-parameter affine model or a 6-parameter affine model; determine, based on the derived affine motion information for the current block of video data, a predictor block of video data; and reconstruct the current block of video data based on the predictor block of video data.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system that may perform the techniques of this disclosure.

FIGS. 2A and 2B are conceptual diagrams illustrating an example quadtree binary tree (QTBT) structure, and a corresponding coding tree unit (CTU).

FIG. 3 is a block diagram illustrating an example video encoder that may perform the techniques of this disclosure.

FIG. 4 is a block diagram illustrating an example video decoder that may perform the techniques of this disclosure.

FIG. 5 is a conceptual diagram illustrating control points for a 6-parameter affine motion model.

FIG. 6 is a conceptual diagram illustrating another example of control points for an affine motion model.

FIG. 7 is conceptual diagram illustrating control points for a current block and a candidate block.

FIG. 8 is conceptual diagram illustrating example candidate blocks.

FIG. 9 is a conceptual diagram illustrating examples of undesirable ternary tree (TT) and binary tree (BT) splits for pipelining.

FIG. 10 is a conceptual diagram illustrating examples of allowed TT and BT splits for pipelining.

FIG. 11 is a conceptual diagram illustrating constrained affine inheritance, in accordance with one or more techniques of this disclosure.

FIG. 12 is a conceptual diagram illustrating constrained affine inheritance, in accordance with one or more techniques of this disclosure.

FIG. 13 is a flowchart illustrating an example method for coding a current block using affine motion compensation, in accordance with one or more aspects of this disclosure.

FIG. 14 is a flowchart illustrating an example method for encoding a current block.

FIG. 15 is a flowchart illustrating an example method for decoding a current block.

### DETAILED DESCRIPTION

In general, this disclosure describes techniques related to coding (e.g., encoding or decoding) of affine motion information for a block of video data. In some example video coding standards, only translational motion models are applied for motion compensation prediction (MCP). When using a translational motion model for MCP, video coders (e.g., video encoders or video decoders) may utilize a single two-dimensional motion vector (MV) for a current block that indicate a displacement between the current block of video data and a corresponding predictor block of video data. The MVs may be two-dimensional in that each MV may have an x-component indicating a horizontal displacement between the current block of video data and the predictor block of video data, and a y-component indicating a vertical displacement between the current block of video data and the predictor block of video data. As discussed in further detail below, in current video coding standards such as HEVC, there are two inter prediction modes, named merge (skip is considered as a special case of merge) and advanced motion vector prediction (AMVP) modes. In merge mode, the value of an MV of a current block is directly inherited from the value of an MV candidate, which may be the value of an MV of a neighboring block of the current block. By contrast, in AMVP mode, the value of the MV candidate may be further refined. In particular, a video coder may signal a value of a difference between the value of the MV candidate and the value of the MV for the current block. The value of the difference may be referred to as a motion vector difference (MVD).

However, there are many kinds of motions other than translational motions, such as zoom in motion, zoom out motions, rotation motions, perspective motions, and other irregular motions. Applying only the translational motion model for MCP in such test sequences with irregular motions may affect the prediction accuracy and may result in low coding efficiency. For instance, using only the translational motion model may result in prediction blocks that are not as well matched to original blocks being coded. As a result, the size of the residual data (i.e., values representing pixel differences between original blocks to be coded and the prediction block) may be increased, which may reduce coding efficiency.

ITU-T VCEG (Q6/16) and ISO/IEC MPEG (JTC 1/SC 29/WG 11) are working together on this exploration activity in a joint collaboration effort known as the Joint Video Exploration Team (JVET) to evaluate compression technology designs proposed by their experts in this area. JVET has released a Joint Exploration Model (JEM) that describes the coding features that are under coordinated test model study as potential enhanced video coding technology beyond the capabilities of HEVC. In JEM, affine motion models are proposed for application to MCP. A recent algorithm description of JEM, “Algorithm Description of Joint Exploration Test Model 2,” Joint Video Exploration Team (JVET) of ITU-T SG 16 WP 3 and ISO/IEC JTC 1/SC 29/WG 11, 2nd Meeting: San Diego, USA, 20-26 Feb. 2016, Document: JVET-B 1001_v3 (hereinafter “JEM test model”) is available from phenix.it-sudparis.eu/jvet/doc_end_user/documents/2_San%20Diego/wg11/JVET-B 1001-v3.zip.

When using affine motion models for MCP, video coder may utilize multiple motion vectors for a current block that collectively indicate an affine transformation (e.g., translation, scaling, reflection, rotation, etc.) between the current block of video data and a corresponding predictor block of video data. For instance, an affine motion model may include a first two-dimensional motion vector indicating a displacement between a top-left corner of a current block and a top-left corner of the corresponding predictor block, and a second two-dimensional motion vector indicating a displacement between a top-right corner of the current block and a top-right corner of the corresponding predictor block. The motion vectors in an affine motion model may be referred to as control point motion vectors (CPMVs) and may be referenced to a location (i.e., a control point) on the current block. For instance, a two-dimensional motion vector that indicates a displacement between a top-left corner of a current block and a top-left corner of the corresponding predictor block may be referred to as the top-left CPMV of the current block. As discussed in further detail below, in the JEM test model, there are two inter prediction modes, affine inter (e.g., AF_INTER) and affine merge (e.g., AF_MERGE).

In affine merge mode, the value for each CPMV of a current block may be directly derived from the CPMVs of a single neighboring block of the current block that is coded using an affine motion model. In other words, in affine merge mode, the CPMVs of the neighboring block are merely warped to the CPMVs of the current block, and there is no flexibility to change or adjust the affine model parameters. In particular, it is not possible to modify the values of the CPMVs using MVDs.

In affine inter mode, the value for each CPMV of a current block is derived individually, based on the value of a MV of a block that neighbors the corresponding control point and an MVD. The value of the MV that a CPMV is determined based on may be referred to as a control point motion vector predictor (CPMVP). As one example, the value of the top-left CPMV of a current block may be derived based on a MV of one of a left block, an above-left block, or an above neighboring block adjacent to the top-left point of the current block and an MVD. As another example, the value of the top-right CPMV of a current block may be derived based on a MV of one of an above-right block or an above neighboring block adjacent to the top-right point of the current block and an MVD.

In both HEVC and the JEM test model, a video encoder may signal the MVD syntax (i.e., syntax elements that represent that value of the MVD) in the bitstream so that the MVs can be reconstructed at the decoder side. The amount of data used to signal the MVD syntax may be related to the size of the MVD value. For instance, more data may be needed to signal the MVD syntax for MVDs with relatively larger values as compared to MVDs with relatively smaller values.

However, the current technique of deriving the value for each CPMV based on the value of a MV of a neighboring block of the corresponding control point may present one or more disadvantages. As one example, the current technique does not take advantage of the correlation of the affine motion model of a current block and the affine motion model of a neighboring block.

A video coder may determine values of motion vectors of an affine motion model of a current block of video data based on values of motion vectors of an affine motion model of a particular neighboring block of video data and values of differences between the values of the motion vectors of the affine motion model for the current block of video data and the values of the motion vectors that are derived based on the affine motion model of the neighboring block of video data. For instance, a video coder may utilize the CPMVs of the neighboring block as CPMVPs for CPMVs of the current block. As the CPMVs of the neighboring block may be correlated with the CPMVs of the current block, the differences (e.g., MVDs) between the predictors (e.g., the CPMVPs) and the motion vectors (e.g., the CPMVs) of the current block may be reduced. In this way, as the amount of data used to encode the differences may be proportional to the size of the difference, the techniques of this disclosure may improve the efficiency of video compression.

A four-parameter affine motion model has been advanced in Huawei Technologies Co, Ltd “Affine transform prediction for next generation video coding” Document ITU-T SG 16 (Study Period 2013) Contribution 1016, (hereinafter “Contribution 1016”) is available from itu.int/md/T13-SG16-C-1016/en. Contribution 1016 introduces a four-parameter affine model shown below in Equation (1).

$$\{ \begin{matrix}{v}_{x} = a x - b y + c \\ {v}_{y} = b x + a y + d\end{matrix} \qquad ( 1 )$$

The variable (v₀ₓ, v_{0y}) is the CPMV for the top-left corner of a current block and (v₁ₓ, v_{1y}) is the CPMV for the top-right corner of the current block, and a, b, c, and d are the four parameters. The affine motion model, also referred to as a motion vector field (MVF), may be represented in accordance with Equation (2) below.

$$\{ \begin{matrix}{v}_{x} = \frac{( {v}_{1 x} - {v}_{{0}_{x}} )}{w} x - \frac{( {v}_{1 y} - {v}_{{0}_{y}} )}{w} y + {v}_{{0}_{x}} \\ {v}_{y} = \frac{( {v}_{1 y} - {v}_{{0}_{y}} )}{w} x + \frac{( {v}_{1 x} - {v}_{{0}_{x}} )}{w} y + {v}_{{0}_{y}}\end{matrix} \qquad ( 2 )$$

The four-parameter affine model shown above in Equation (1) may present one or more disadvantages. In particular, the four-parameter affine motion constrains the affine parameters of the x and y components, forcing them to have symmetric scaling properties. However, this constraint may not be true in diversified video content.

In some examples, a video coder may utilize a six-parameter affine motion model. For instance, a video decoder may determine whether a current block is coded using the four-parameter affine motion model shown above in Equation (1) or a six-parameter affine motion model shown below in Equation (3).

$$\{ \begin{matrix}{v}_{x} = a x - b y + c \\ {v}_{y} = dx + ey + f\end{matrix} \qquad ( 3 )$$

The variable (v₀, v_{0y}) is the CPMV for the top-left corner of a current block, (v₁ₓ, v_{1y}) is the CPMV for the top-right corner of the current block, (v₂ₓ, v_{2y}) is the CPMV for the bottom-left corner of the current block, and a, b, c, d, e, and f are the six parameters. The motion field for the six-parameter model may be described as

$$\{ \begin{matrix}{v}_{x} = \frac{( {v}_{1 x} - {v}_{{0}_{x}} )}{w} x + \frac{( {v}_{2 x} - {v}_{{0}_{x}} )}{h} y + {v}_{{0}_{x}} \\ {v}_{y} = \frac{( {v}_{1 y} - {v}_{{0}_{y}} )}{w} x + \frac{( {v}_{2 y} - {v}_{{0}_{y}} )}{h} y + {v}_{{0}_{y}}\end{matrix} \qquad ( 4 )$$

where w and h are the width and height of the block.

In some examples, the video decoder may determine which affine motion model is used based on explicit signalling or by inference. For instance, the video coder may decode, from a bitstream, a syntax element that indicates whether the affine motion model for a current block of video data comprises a four-parameter model or a six-parameter model. In some examples, the syntax element may be coded in one or more of a video parameter set (VPS), sequence parameter set (SPS), picture parameter set (PPS), and a slice header referred to by the current block of video data. In some examples, the syntax element may be coded at the coding unit (CU) level of a CU that includes the current block of video data.

The processing and/or signaling requirements of the four-parameter model may be lower than the processing and/or signaling requirements of the six-parameter model. However, in some examples, the six-parameter model may result in prediction blocks that better match the block being coded, which may reduce the size of the residual values. As such, in some examples, a video encoder may balance the processing and signaling costs of encoding a block using a six-parameter model against the benefits of reduced residual values for the block and may select which model is more advantageous. In this way, the techniques of this disclosure may further improve the efficiency of video compression using affine motion models.

In accordance with one or more techniques of this disclosure, a video coder may selectively constrain affine motion inheritance from a neighboring block to use either 4-parameter inheritance or 6-parameter inheritance based on whether the current block and the neighboring block are located in the same VPDU. For instance, where the current block and the neighboring block are located in the same VPDU and the neighboring block is coded using a 6-parameter affine model, the video coder may determine values for CPMVs of the current block based on values of all three CPMVs of the neighboring block (e.g., perform 6-parameter inheritance). However, where the current block and the neighboring block are located in different VPDUs and the neighboring block is coded using a 6-parameter affine model, the video coder may determine values for CPMVs of the current block based on values of two of the three CPMVs of the neighboring block (e.g., perform 4-parameter inheritance). As such, where the current block and the neighboring block are located in different VPDUs, the video coder may only need to store values for two of the three motion vectors of the neighboring block. In this way, the techniques of this disclosure enable a video coder to reduce amount of information stored in the inter-VPDU data buffer.

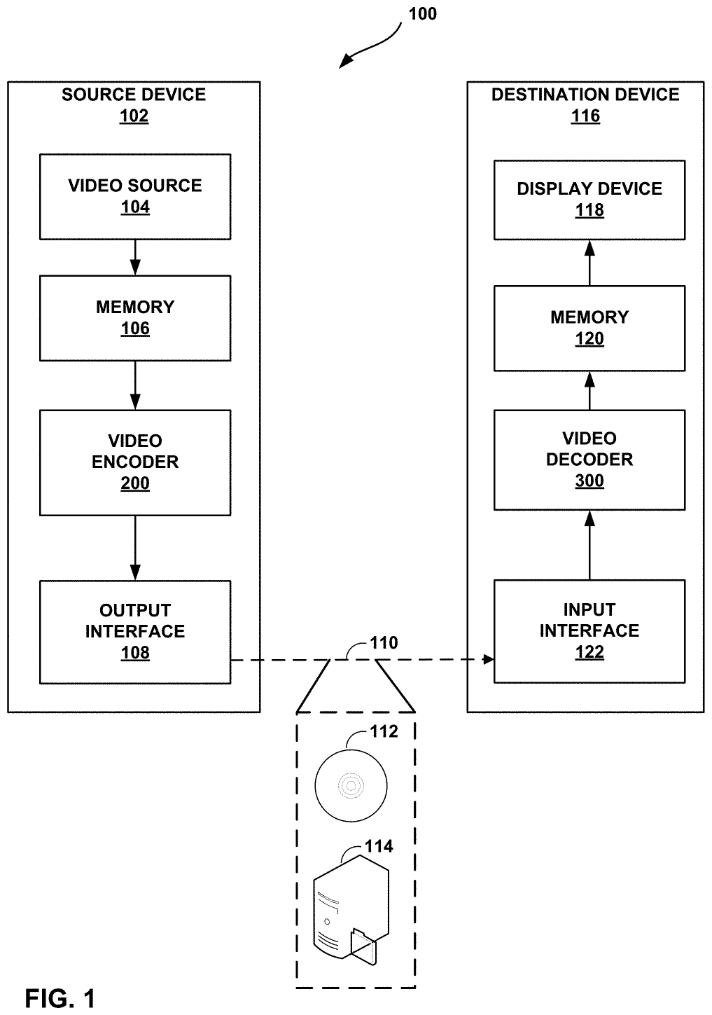

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, uncoded video, encoded video, decoded (e.g., reconstructed) video, and video metadata, such as signaling data.

As shown in FIG. 1, the system 100 includes a source device 102 that provides encoded video data to be decoded and displayed by a destination device 116, in this example. In particular, the source device 102 provides the video data to the destination device 116 via a computer-readable medium 110. The source device 102 and the destination device 116 may comprise any of a wide range of devices, including desktop computers, notebook (i.e., laptop) computers, tablet computers, set-top boxes, telephone handsets such smartphones, televisions, cameras, display devices, digital media players, video gaming consoles, video streaming device, or the like. In some cases, the source device 102 and the destination device 116 may be equipped for wireless communication, and thus may be referred to as wireless communication devices.

In the example of FIG. 1, the source device 102 includes video source 104, memory 106, video encoder 200, and output interface 108. The destination device 116 includes input interface 122, video decoder 300, memory 120, and display device 118. In accordance with this disclosure, the video encoder 200 of the source device 102 and the video decoder 300 of the destination device 116 may be configured to apply the techniques for constrained affine motion inheritance. Thus, the source device 102 represents an example of a video encoding device, while the destination device 116 represents an example of a video decoding device. In other examples, a source device and a destination device may include other components or arrangements. For example, the source device 102 may receive video data from an external video source, such as an external camera. Likewise, the destination device 116 may interface with an external display device, rather than including an integrated display device.

The system 100 as shown in FIG. 1 is merely one example. In general, any digital video encoding and/or decoding device may perform techniques for constrained affine motion inheritance. The source device 102 and the destination device 116 are merely examples of such coding devices in which source device 102 generates coded video data for transmission to the destination device 116. This disclosure refers to a “coding” device as a device that performs coding (encoding and/or decoding) of data. Thus, the video encoder 200 and the video decoder 300 represent examples of coding devices, in particular, a video encoder and a video decoder, respectively. In some examples, the source device 102 and the destination device 116 may operate in a substantially symmetrical manner such that each of the source device 102 and the destination device 116 include video encoding and decoding components. Hence, the system 100 may support one-way or two-way video transmission between the source device 102 and the destination device 116, e.g., for video streaming, video playback, video broadcasting, or video telephony.

In general, the video source 104 represents a source of video data (i.e., raw, unencoded video data) and provides a sequential series of pictures (also referred to as “frames”) of the video data to the video encoder 200, which encodes data for the pictures. The video source 104 of the source device 102 may include a video capture device, such as a video camera, a video archive containing previously captured raw video, and/or a video feed interface to receive video from a video content provider. As a further alternative, the video source 104 may generate computer graphics-based data as the source video, or a combination of live video, archived video, and computer-generated video. In each case, the video encoder 200 encodes the captured, pre-captured, or computer-generated video data. The video encoder 200 may rearrange the pictures from the received order (sometimes referred to as “display order”) into a coding order for coding. The video encoder 200 may generate a bitstream including encoded video data. The source device 102 may then output the encoded video data via output interface 108 onto computer-readable medium 110 for reception and/or retrieval by, e.g., input interface 122 of the destination device 116.

Memory 106 of the source device 102 and memory 120 of the destination device 116 represent general purpose memories. In some example, the memory 106 and the memory 120 may store raw video data, e.g., raw video from the video source 104 and raw, decoded video data from the video decoder 300. Additionally or alternatively, the memory 106 and the memory 120 may store software instructions executable by, e.g., the video encoder 200 and the video decoder 300, respectively. Although shown separately from the video encoder 200 and the video decoder 300 in this example, it should be understood that the video encoder 200 and the video decoder 300 may also include internal memories for functionally similar or equivalent purposes. Furthermore, the memory 106 and the memory 120 may store encoded video data, e.g., output from the video encoder 200 and input to the video decoder 300. In some examples, portions of the memory 106 and the memory 120 may be allocated as one or more video buffers, e.g., to store raw, decoded, and/or encoded video data.

Computer-readable medium 110 may represent any type of medium or device capable of transporting the encoded video data from the source device 102 to the destination device 116. In one example, computer-readable medium 110 represents a communication medium to enable the source device 102 to transmit encoded video data directly to the destination device 116 in real-time, e.g., via a radio frequency network or computer-based network. Output interface 108 may modulate a transmission signal including the encoded video data, and input interface 122 may modulate the received transmission signal, according to a communication standard, such as a wireless communication protocol. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 102 to the destination device 116.

In some examples, the source device 102 may output encoded data from the output interface 108 to storage device 112. Similarly, the destination device 116 may access encoded data from the storage device 112 via the input interface 122. The storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, the source device 102 may output encoded video data to file server 114 or another intermediate storage device that may store the encoded video generated by the source device 102. The destination device 116 may access stored video data from the file server 114 via streaming or download. The file server 114 may be any type of server device capable of storing encoded video data and transmitting that encoded video data to the destination device 116. The file server 114 may represent a web server (e.g., for a website), a File Transfer Protocol (FTP) server, a content delivery network device, or a network attached storage (NAS) device. The destination device 116 may access encoded video data from the file server 114 through any standard data connection, including an Internet connection. This may include a wireless channel (e.g., a Wi-Fi connection), a wired connection (e.g., DSL, cable modem, etc.), or a combination of both that is suitable for accessing encoded video data stored on the file server 114. The file server 114 and the input interface 122 may be configured to operate according to a streaming transmission protocol, a download transmission protocol, or a combination thereof.

The output interface 108 and the input interface 122 may represent wireless transmitters/receiver, modems, wired networking components (e.g., Ethernet cards), wireless communication components that operate according to any of a variety of IEEE 802.11 standards, or other physical components. In examples where the output interface 108 and the input interface 122 comprise wireless components, the output interface 108 and the input interface 122 may be configured to transfer data, such as encoded video data, according to a cellular communication standard, such as 4G, 4G-LTE (Long-Term Evolution), LTE Advanced, 5G, or the like. In some examples where the output interface 108 comprises a wireless transmitter, the output interface 108 and the input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, the source device 102 and/or the destination device 116 may include respective system-on-a-chip (SoC) devices. For example, the source device 102 may include an SoC device to perform the functionality attributed to the video encoder 200 and/or the output interface 108, and the destination device 116 may include an SoC device to perform the functionality attributed to the video decoder 300 and/or the input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

The input interface 122 of the destination device 116 may receive an encoded video bitstream from the computer-readable medium 110 (e.g., the storage device 112, the file server 114, or the like). The encoded video bitstream from the computer-readable medium 110 may include signaling information defined by the video encoder 200, which is also used by the video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. The display device 118 may represent any of a variety of display devices such as a cathode ray tube (CRT), a liquid crystal display (LCD), a plasma display, an organic light emitting diode (OLED) display, or another type of display device.

Although not shown in FIG. 1, in some examples, the video encoder 200 and the video decoder 300 may each be integrated with an audio encoder and/or audio decoder, and may include appropriate MUX-DEMUX units, or other hardware and/or software, to handle multiplexed streams including both audio and video in a common data stream. If applicable, MUX-DEMUX units may conform to the ITU H.223 multiplexer protocol, or other protocols such as the user datagram protocol (UDP).

The video encoder 200 and the video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 200 and the video decoder 300 may be included in one or more encoders or decoders, either of which may be integrated as part of a combined encoder/decoder (CODEC) in a respective device. A device including the video encoder 200 and/or the video decoder 300 may comprise an integrated circuit, a microprocessor, and/or a wireless communication device, such as a cellular telephone.

The video encoder 200 and the video decoder 300 may operate according to a video coding standard, such as ITU-T H.265, also referred to as High Efficiency Video Coding (HEVC) or extensions thereto, such as the multi-view and/or scalable video coding extensions. Alternatively, the video encoder 200 and the video decoder 300 may operate according to other proprietary or industry standards, such as the Joint Exploration Test Model (JEM) or ITU-T H.266, also referred to as Versatile Video Coding (VVC). A recent draft of the VVC standard is described in Bross, et al. “Versatile Video Coding (Draft 3),” Joint Video Experts Team (JVET) of ITU-T SG 16 WP 3 and ISO/IEC JTC 1/SC 29/WG 11, 12^{th} Meeting: Macao, CN, 3-12 Oct. 2018, JVET-L1001-v9 (hereinafter “VVC Draft 3). The techniques of this disclosure, however, are not limited to any particular coding standard.

In general, the video encoder 200 and the video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, the video encoder 200 and the video decoder 300 may code video data represented in a YUV (e.g., Y, Cb, Cr) format. That is, rather than coding red, green, and blue (RGB) data for samples of a picture, the video encoder 200 and the video decoder 300 may code luminance and chrominance components, where the chrominance components may include both red hue and blue hue chrominance components. In some examples, the video encoder 200 converts received RGB formatted data to a YUV representation prior to encoding, and the video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as the video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, the video encoder 200 and the video decoder 300 may be configured to operate according to JEM or VVC. According to JEM or VVC, a video coder (such as the video encoder 200) partitions a picture into a CTUs. The video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) partitions. A triple tree partition is a partition where a block is split into three sub-blocks. In some examples, a triple tree partition divides a block into three sub-blocks without dividing the original block through the center. The partitioning types in MTT (e.g., QT, BT, and TT), may be symmetrical or asymmetrical.

In some examples, the video encoder 200 and the video decoder 300 may use a single QTBT or MTT structure to represent each of the luminance and chrominance components, while in other examples, the video encoder 200 and the video decoder 300 may use two or more QTBT or MTT structures, such as one QTBT/MTT structure for the luminance component and another QTBT/MTT structure for both chrominance components (or two QTBT/MTT structures for respective chrominance components).

The video encoder 200 and the video decoder 300 may be configured to use quadtree partitioning per HEVC, QTBT partitioning, MTT partitioning, or other partitioning structures. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

The video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, the video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, the video encoder 200 may generate the prediction block using one or more motion vectors. The video encoder 200 may generally perform a motion search to identify a reference block that closely matches the CU, e.g., in terms of differences between the CU and the reference block. The video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, the video encoder 200 may predict the current CU using uni-directional prediction or bi-directional prediction.

Some examples of JEM and VVC also provide an affine motion compensation mode, which may be considered an inter-prediction mode. In affine motion compensation mode, the video encoder 200 may determine two or more motion vectors that represent non-translational motion, such as zoom in or out, rotation, perspective motion, or other irregular motion types.

To perform intra-prediction, the video encoder 200 may select an intra-prediction mode to generate the prediction block. Some examples of JEM and VVC provide sixty-seven intra-prediction modes, including various directional modes, as well as planar mode and DC mode. In general, the video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming the video encoder 200 codes CTUs and CUs in raster scan order (left to right, top to bottom).

The video encoder 200 encodes data representing the prediction mode for a current block. For example, for inter-prediction modes, the video encoder 200 may encode data representing which of the various available inter-prediction modes is used, as well as motion information for the corresponding mode. For uni-directional or bi-directional inter-prediction, for example, the video encoder 200 may encode motion vectors using advanced motion vector prediction (AMVP) or merge mode. The video encoder 200 may use similar modes to encode motion vectors for affine motion compensation mode.

Following prediction, such as intra-prediction or inter-prediction of a block, the video encoder 200 may calculate residual data for the block. The residual data, such as a residual block, represents sample by sample differences between the block and a prediction block for the block, formed using the corresponding prediction mode. The video encoder 200 may apply one or more transforms to the residual block, to produce transformed data in a transform domain instead of the sample domain. For example, the video encoder 200 may apply a discrete cosine transform (DCT), an integer transform, a wavelet transform, or a conceptually similar transform to residual video data. Additionally, the video encoder 200 may apply a secondary transform following the first transform, such as a mode-dependent non-separable secondary transform (MDNSST), a signal dependent transform, a Karhunen-Loeve transform (KLT), or the like. The video encoder 200 produces transform coefficients following application of the one or more transforms.

As noted above, following any transforms to produce transform coefficients, the video encoder 200 may perform quantization of the transform coefficients. Quantization generally refers to a process in which transform coefficients are quantized to possibly reduce the amount of data used to represent the coefficients, providing further compression. By performing the quantization process, the video encoder 200 may reduce the bit depth associated with some or all of the coefficients. For example, the video encoder 200 may round an n-bit value down to an m-bit value during quantization, where n is greater than m. In some examples, to perform quantization, the video encoder 200 may perform a bitwise right-shift of the value to be quantized.

Following quantization, the video encoder 200 may scan the transform coefficients, producing a one-dimensional vector from the two-dimensional matrix including the quantized transform coefficients. The scan may be designed to place higher energy (and therefore lower frequency) coefficients at the front of the vector and to place lower energy (and therefore higher frequency) transform coefficients at the back of the vector. In some examples, the video encoder 200 may utilize a predefined scan order to scan the quantized transform coefficients to produce a serialized vector, and then entropy encode the quantized transform coefficients of the vector. In other examples, the video encoder 200 may perform an adaptive scan. After scanning the quantized transform coefficients to form the one-dimensional vector, the video encoder 200 may entropy encode the one-dimensional vector, e.g., according to context-adaptive binary arithmetic coding (CABAC). The video encoder 200 may also entropy encode values for syntax elements describing metadata associated with the encoded video data for use by the video decoder 300 in decoding the video data.

To perform CABAC, the video encoder 200 may assign a context within a context model to a symbol to be transmitted. The context may relate to, for example, whether neighboring values of the symbol are zero-valued or not. The probability determination may be based on a context assigned to the symbol.

The video encoder 200 may further generate syntax data, such as block-based syntax data, picture-based syntax data, and sequence-based syntax data, to the video decoder 300, e.g., in a picture header, a block header, a slice header, or other syntax data, such as a sequence parameter set (SPS), picture parameter set (PPS), or video parameter set (VPS). The video decoder 300 may likewise decode such syntax data to determine how to decode corresponding video data.

In this manner, the video encoder 200 may generate a bitstream including encoded video data, e.g., syntax elements describing partitioning of a picture into blocks (e.g., CUs) and prediction and/or residual information for the blocks. Ultimately, the video decoder 300 may receive the bitstream and decode the encoded video data.

In general, the video decoder 300 performs a reciprocal process to that performed by the video encoder 200 to decode the encoded video data of the bitstream. For example, the video decoder 300 may decode values for syntax elements of the bitstream using CABAC in a manner substantially similar to, albeit reciprocal to, the CABAC encoding process of the video encoder 200. The syntax elements may define partitioning information of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. The video decoder 300 may inverse quantize and inverse transform the quantized transform coefficients of a block to reproduce a residual block for the block. The video decoder 300 uses a signaled prediction mode (intra- or inter-prediction) and related prediction information (e.g., motion information for inter-prediction) to form a prediction block for the block. The video decoder 300 may then combine the prediction block and the residual block (on a sample-by-sample basis) to reproduce the original block. The video decoder 300 may perform additional processing, such as performing a deblocking process to reduce visual artifacts along boundaries of the block.

In accordance with the techniques of this disclosure, as will be explained in more detail below, the video encoder 200 and the video decoder 300 may be configured to code a block of video data using an affine coding mode and constrained affine motion inheritance. For instance, responsive to determining to inherit affine motion information for a current block of video data located in a current VPDU from a neighboring block of video data located in a different VPDU, the video coder may derive the affine motion information for the current block from two sub-block motion vectors of the neighboring block of video data; determine, based on the derived affine motion information for the current block of video data, a predictor block of video data; and reconstruct the current block of video data based on the predictor block of video data.

This disclosure may generally refer to “signaling” certain information, such as syntax elements. The term “signaling” may generally refer to the communication of values syntax elements and/or other data used to decode encoded video data. That is, the video encoder 200 may signal values for syntax elements in the bitstream. In general, signaling refers to generating a value in the bitstream. As noted above, the source device 102 may transport the bitstream to the destination device 116 substantially in real time, or not in real time, such as might occur when storing syntax elements to the storage device 112 for later retrieval by the destination device 116.

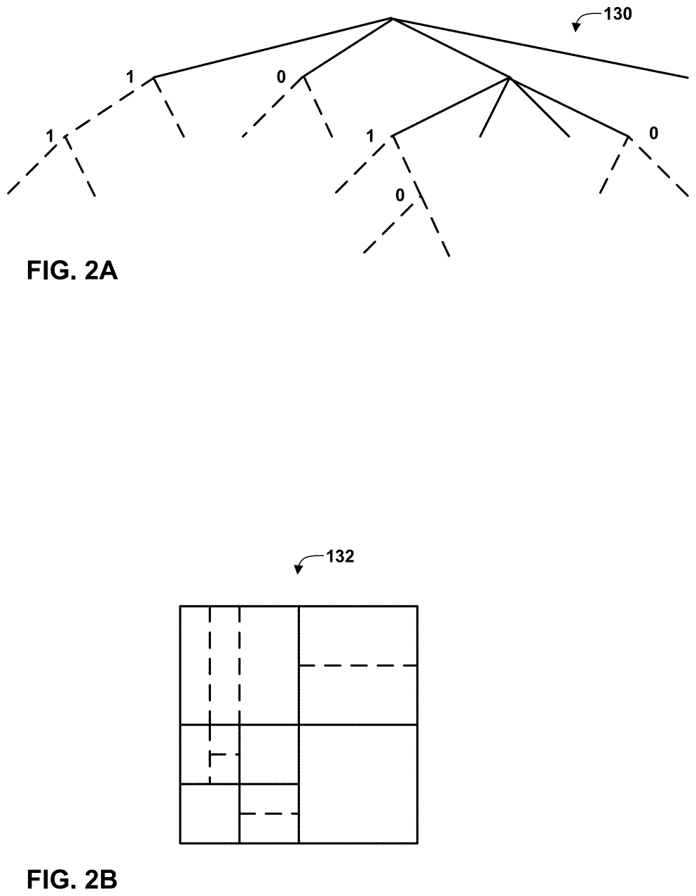

FIGS. 2A and 2B are conceptual diagram illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. For the quadtree splitting, there is no need to indicate the splitting type, since quadtree nodes split a block horizontally and vertically into 4 sub-blocks with equal size. Accordingly, video encoder 200 may encode, and video decoder 300 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 200 may encode, and video decoder 300 may decode, video data, such as prediction and transform data, for CUs represented by terminal leaf nodes of QTBT structure 130.

In general, CTU 132 of FIG. 2B may be associated with parameters defining sizes of blocks corresponding to nodes of QTBT structure 130 at the first and second levels. These parameters may include a CTU size (representing a size of CTU 132 in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of a QTBT structure corresponding to a CTU may have four child nodes at the first level of the QTBT structure, each of which may be partitioned according to quadtree partitioning. That is, nodes of the first level are either leaf nodes (having no child nodes) or have four child nodes. The example of QTBT structure 130 represents such nodes as including the parent node and child nodes having solid lines for branches. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The example of QTBT structure 130 represents such nodes as having dashed lines for branches. The binary tree leaf node is referred to as a coding unit (CU), which is used for prediction (e.g., intra-picture or inter-picture prediction) and transform, without any further partitioning. As discussed above, CUs may also be referred to as “video blocks” or “blocks.”

In one example of the QTBT partitioning structure, the CTU size is set as 128×128 (luma samples and two corresponding 64×64 chroma samples), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, a binary tree node having a height equal to MinBTSize implies no further vertical splitting is permitted for that binary tree node. As noted above, leaf nodes of the binary tree are referred to as CUs, and are further processed according to prediction and transform without further partitioning.

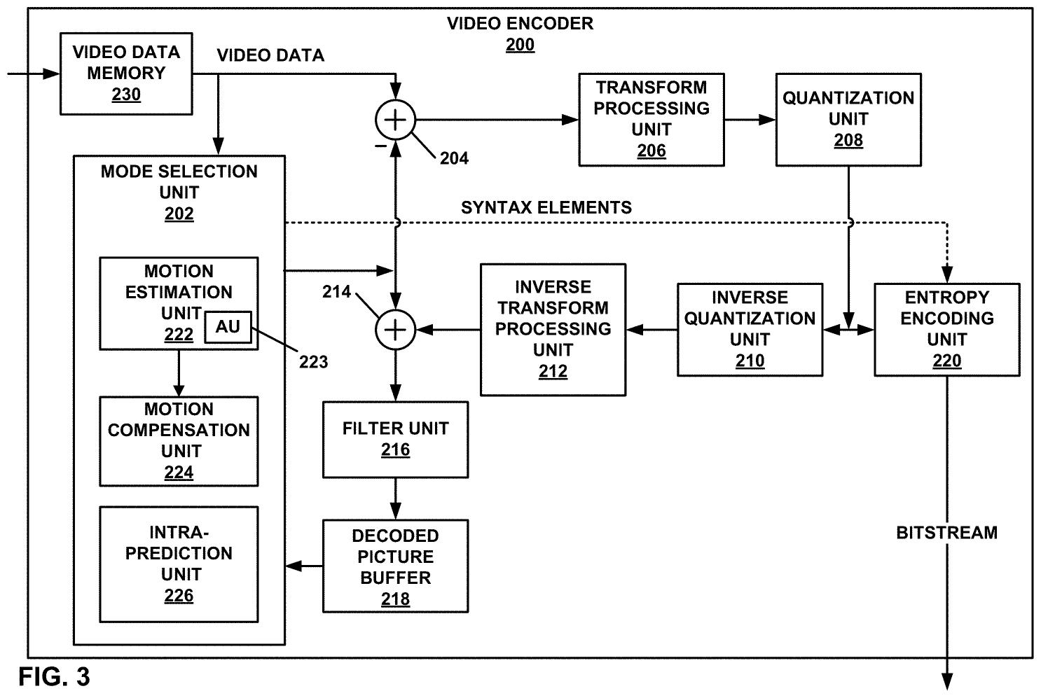

FIG. 3 is a block diagram illustrating an example video encoder 200 that may perform the techniques of this disclosure. FIG. 3 is provided for purposes of explanation and should not be considered limiting of the techniques as broadly exemplified and described in this disclosure. For purposes of explanation, this disclosure describes the video encoder 200 in the context of video coding standards such as the HEVC video coding standard and the H.266 video coding standard in development. However, the techniques of this disclosure are not limited to these video coding standards, and are applicable generally to video encoding and decoding.

In the example of FIG. 3, the video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of the video data memory 230, the mode selection unit 202, the residual generation unit 204, the transform processing unit 206, the quantization unit 208, the inverse quantization unit 210, the inverse transform processing unit 212, the reconstruction unit 214, the filter unit 216, the DPB 218, and the entropy encoding unit 220 may be implemented in one or more processors or in processing circuitry. Moreover, the video encoder 200 may include additional or alternative processors or processing circuitry to perform these and other functions.

The video data memory 230 may store video data to be encoded by the components of the video encoder 200. The video encoder 200 may receive the video data stored in the video data memory 230 from, for example, the video source 104 (FIG. 1). The DPB 218 may act as a reference picture memory that stores reference video data for use in prediction of subsequent video data by the video encoder 200. The video data memory 230 and the DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. The video data memory 230 and the DPB 218 may be provided by the same memory device or separate memory devices. In various examples, the video data memory 230 may be on-chip with other components of the video encoder 200, as illustrated, or off-chip relative to those components.

In this disclosure, reference to the video data memory 230 should not be interpreted as being limited to memory internal to the video encoder 200, unless specifically described as such, or memory external to the video encoder 200, unless specifically described as such. Rather, reference to the video data memory 230 should be understood as reference memory that stores video data that the video encoder 200 receives for encoding (e.g., video data for a current block that is to be encoded). The memory 106 of FIG. 1 may also provide temporary storage of outputs from the various units of the video encoder 200.

The various units of FIG. 3 are illustrated to assist with understanding the operations performed by the video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

The video encoder 200 may include arithmetic logic units (ALUs), elementary function units (EFUs), digital circuits, analog circuits, and/or programmable cores, formed from programmable circuits. In examples where the operations of the video encoder 200 are performed using software executed by the programmable circuits, memory 106 (FIG. 1) may store the object code of the software that the video encoder 200 receives and executes, or another memory within the video encoder 200 (not shown) may store such instructions.

The video data memory 230 is configured to store received video data. The video encoder 200 may retrieve a picture of the video data from the video data memory 230 and provide the video data to residual generation unit 204 and mode selection unit 202. Video data in the video data memory 230 may be raw video data that is to be encoded.

The mode selection unit 202 includes a motion estimation unit 222, motion compensation unit 224, and an intra-prediction unit 226. The mode selection unit 202 may include additional functional units to perform video prediction in accordance with other prediction modes. As examples, the mode selection unit 202 may include a palette unit, an intra-block copy unit (which may be part of the motion estimation unit 222 and/or the motion compensation unit 224), an affine unit (AU) 223, a linear model (LM) unit, or the like.

The mode selection unit 202 generally coordinates multiple encoding passes to test combinations of encoding parameters and resulting rate-distortion values for such combinations. The encoding parameters may include partitioning of CTUs into CUs, prediction modes for the CUs, transform types for residual data of the CUs, quantization parameters for residual data of the CUs, and so on. The mode selection unit 202 may ultimately select the combination of encoding parameters having rate-distortion values that are better than the other tested combinations.

The video encoder 200 may partition a picture retrieved from the video data memory 230 into a series of CTUs, and encapsulate one or more CTUs within a slice. The mode selection unit 202 may partition a CTU of the picture in accordance with a tree structure, such as the QTBT structure or the quad-tree structure of HEVC described above. As described above, the video encoder 200 may form one or more CUs from partitioning a CTU according to the tree structure. Such a CU may also be referred to generally as a “video block” or “block.”

In general, the mode selection unit 202 also controls the components thereof (e.g., the motion estimation unit 222, the motion compensation unit 224, and the intra-prediction unit 226) to generate a prediction block for a current block (e.g., a current CU, or in HEVC, the overlapping portion of a PU and a TU). For inter-prediction of a current block, the motion estimation unit 222 may perform a motion search to identify one or more closely matching reference blocks in one or more reference pictures (e.g., one or more previously coded pictures stored in the DPB 218). In particular, the motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. The motion estimation unit 222 may generally perform these calculations using sample-by-sample differences between the current block and the reference block being considered. The motion estimation unit 222 may identify a reference block having a lowest value resulting from these calculations, indicating a reference block that most closely matches the current block.

The motion estimation unit 222 may form one or more motion vectors (MVs) that defines the positions of the reference blocks in the reference pictures relative to the position of the current block in a current picture. The motion estimation unit 222 may then provide the motion vectors to the motion compensation unit 224. For example, for uni-directional inter-prediction, the motion estimation unit 222 may provide a single motion vector, whereas for bi-directional inter-prediction, the motion estimation unit 222 may provide two motion vectors. The motion compensation unit 224 may then generate a prediction block using the motion vectors. For example, the motion compensation unit 224 may retrieve data of the reference block using the motion vector. As another example, if the motion vector has fractional sample precision, the motion compensation unit 224 may interpolate values for the prediction block according to one or more interpolation filters. Moreover, for bi-directional inter-prediction, the motion compensation unit 224 may retrieve data for two reference blocks identified by respective motion vectors and combine the retrieved data, e.g., through sample-by-sample averaging or weighted averaging.

As another example, for intra-prediction, or intra-prediction coding, the intra-prediction unit 226 may generate the prediction block from samples neighboring the current block. For example, for directional modes, the intra-prediction unit 226 may generally mathematically combine values of neighboring samples and populate these calculated values in the defined direction across the current block to produce the prediction block. As another example, for DC mode, the intra-prediction unit 226 may calculate an average of the neighboring samples to the current block and generate the prediction block to include this resulting average for each sample of the prediction block.

The mode selection unit 202 provides the prediction block to the residual generation unit 204. The residual generation unit 204 receives a raw, uncoded version of the current block from the video data memory 230 and the prediction block from the mode selection unit 202. The residual generation unit 204 calculates sample-by-sample differences between the current block and the prediction block. The resulting sample-by-sample differences define a residual block for the current block. In some examples, the residual generation unit 204 may also determine differences between sample values in the residual block to generate a residual block using residual differential pulse code modulation (RDPCM). In some examples, the residual generation unit 204 may be formed using one or more subtractor circuits that perform binary subtraction.

In examples where the mode selection unit 202 partitions CUs into PUs, each PU may be associated with a luma prediction unit and corresponding chroma prediction units. The video encoder 200 and the video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, the video encoder 200 may support PU sizes of 2N×2N or N×N for intra prediction, and symmetric PU sizes of 2N×2N, 2N×N, N×2N, N×N, or similar for inter prediction. The video encoder 200 and the video decoder 300 may also support asymmetric partitioning for PU sizes of 2N×nU, 2N×nD, nL×2N, and nR×2N for inter prediction.

In examples where mode selection unit does not further partition a CU into PUs, each CU may be associated with a luma coding block and corresponding chroma coding blocks. As above, the size of a CU may refer to the size of the luma coding block of the CU. The video encoder 200 and the video decoder 300 may support CU sizes of 2N×2N, 2N×N, or N×2N.

For other video coding techniques such as an intra-block copy mode coding, an affine mode coding, and linear model (LM) mode coding, as few examples, mode selection unit 202, via respective units associated with the coding techniques, generates a prediction block for the current block being encoded. For example, in the case of affine mode coding, the affine unit 223 may determine delta motion vectors from control point motion vectors (CPMVs) of a neighboring block of a current block of video data, scale the delta motion vectors and clip the delta motion vectors when generating a prediction block for the current block of video data being encoded. In some examples, such as palette mode coding, the mode selection unit 202 may not generate a prediction block, and instead generate syntax elements that indicate the manner in which to reconstruct the block based on a selected palette. In such modes, the mode selection unit 202 may provide these syntax elements to the entropy encoding unit 220 to be encoded.

As described above, the residual generation unit 204 receives the video data for the current block and the corresponding prediction block. The residual generation unit 204 then generates a residual block for the current block. To generate the residual block, the residual generation unit 204 calculates sample-by-sample differences between the prediction block and the current block.

The transform processing unit 206 applies one or more transforms to the residual block to generate a block of transform coefficients (referred to herein as a “transform coefficient block”). The transform processing unit 206 may apply various transforms to a residual block to form the transform coefficient block. For example, the transform processing unit 206 may apply a discrete cosine transform (DCT), a directional transform, a Karhunen-Loeve transform (KLT), or a conceptually similar transform to a residual block. In some examples, the transform processing unit 206 may perform multiple transforms to a residual block, e.g., a primary transform and a secondary transform, such as a rotational transform. In some examples, the transform processing unit 206 does not apply transforms to a residual block.

Quantization unit 208 may quantize the transform coefficients in a transform coefficient block, to produce a quantized transform coefficient block. The quantization unit 208 may quantize transform coefficients of a transform coefficient block according to a quantization parameter (QP) value associated with the current block. The video encoder 200 (e.g., via the mode selection unit 202) may adjust the degree of quantization applied to the coefficient blocks associated with the current block by adjusting the QP value associated with the CU. Quantization may introduce loss of information, and thus, quantized transform coefficients may have lower precision than the original transform coefficients produced by the transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by the mode selection unit 202. For example, the reconstruction unit 214 may add samples of the reconstructed residual block to corresponding samples from the prediction block generated by the mode selection unit 202 to produce the reconstructed block.

Filter unit 216 may perform one or more filter operations on reconstructed blocks. For example, the filter unit 216 may perform deblocking operations to reduce blockiness artifacts along edges of CUs. Operations of the filter unit 216 may be skipped, in some examples.

The video encoder 200 stores reconstructed blocks in the DPB 218. For instance, in examples where operations of the filter unit 216 are not needed, the reconstruction unit 214 may store reconstructed blocks to the DPB 218. In examples where operations of the filter unit 216 are needed, the filter unit 216 may store the filtered reconstructed blocks to the DPB 218. The motion estimation unit 222 and the motion compensation unit 224 may retrieve a reference picture from the DPB 218, formed from the reconstructed (and potentially filtered) blocks, to inter-predict blocks of subsequently encoded pictures. In addition, the intra-prediction unit 226 may use reconstructed blocks in the DPB 218 of a current picture to intra-predict other blocks in the current picture.

In general, the entropy encoding unit 220 may entropy encode syntax elements received from other functional components of the video encoder 200. For example, the entropy encoding unit 220 may entropy encode quantized transform coefficient blocks from the quantization unit 208. As another example, the entropy encoding unit 220 may entropy encode prediction syntax elements (e.g., motion information for inter-prediction or intra-mode information for intra-prediction) from the mode selection unit 202. The entropy encoding unit 220 may perform one or more entropy encoding operations on the syntax elements, which are another example of video data, to generate entropy-encoded data. For example, the entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, the entropy encoding unit 220 may operate in bypass mode where syntax elements are not entropy encoded.

The video encoder 200 may output a bitstream that includes the entropy encoded syntax elements needed to reconstruct blocks of a slice or picture. For example, the entropy encoding unit 220 may output the bitstream.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a MV and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding blocks and the chroma coding blocks.

In accordance with one or more techniques of this disclosure, video encoder 200 may selectively constrain affine motion inheritance from a neighboring block to use either 4-parameter inheritance or 6-parameter inheritance based on whether the current block and the neighboring block are located in the same VPDU. For instance, where the current block and the neighboring block are located in the same VPDU and the neighboring block is coded using a 6-parameter affine model, the affine unit 223 of video encoder 200 may determine values for CPMVs of the current block based on values of all three CPMVs of the neighboring block (e.g., perform 6-parameter inheritance). However, where the current block and the neighboring block are located in different VPDUs and the neighboring block is coded using a 6-parameter affine model, the affine unit 223 may determine values for CPMVs of the current block based on values of two of the three CPMVs of the neighboring block (e.g., perform 4-parameter inheritance). As such, where the current block and the neighboring block are located in different VPDUs, the affine unit 223 may only need to store values for two of the three motion vectors of the neighboring block. In this way, the techniques of this disclosure enable video encoder 200 to reduce amount of information stored in an inter-VPDU data buffer.

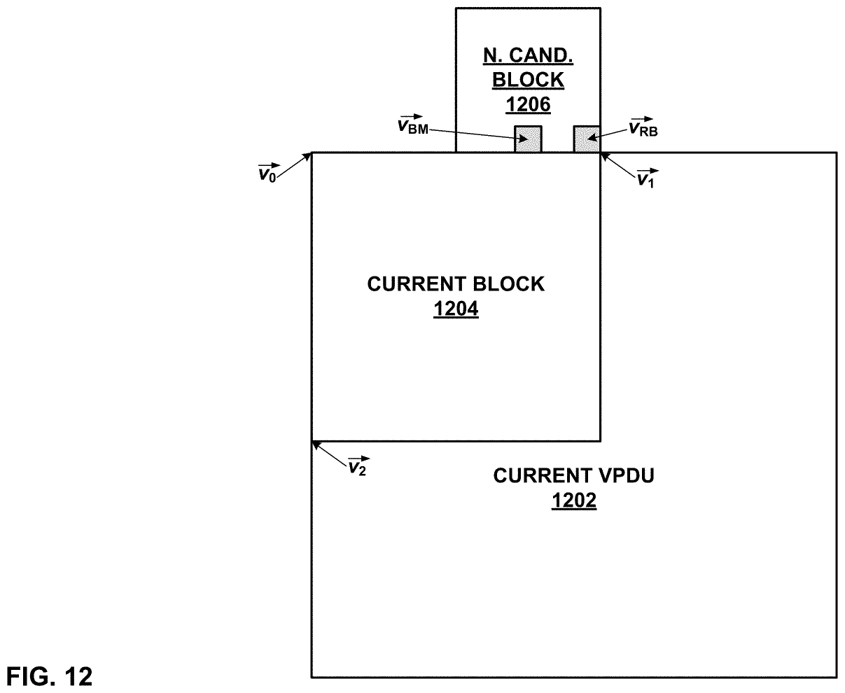

For instance, video encoder 200 may store all subblock motion vectors for a whole VPDU. For regular motion vector prediction, video encoder 200 may store an additional line of subblock motion vectors that are immediate neighbors of current VPDU. Affine motion inheritance from a different VPDU is not constrained, video encoder 200 may have to utilize an extra buffer (e.g., extra storage capacity) to store the third CPMV. On the other hand, by utilizing the techniques of this disclosure and constraining affine motion inheritance from a different VPDU to use only two CPMVs, video encoder 200 may not need that extra buffer, since the selected two CPMVs are already stored in the line of subblock motion vectors anyway. For example, the V_BM and V_RB are already stored for regular motion vector prediction in FIG. 12.

The video encoder 200 represents an example of a device configured to encode video data including a memory configured to store video data, and one or more processing units implemented in circuitry and configured to derive, responsive to determining to inherit affine motion information for a current block of video data located in a current virtual pipeline data unit (VPDU) from a neighboring block of video data located in a different VPDU, the affine motion information for the current block from two sub-block motion vectors of the neighboring block of video data; determine, based on the derived affine motion information for the current block of video data, a predictor block of video data; and reconstruct the current block of video data based on the predictor block of video data.

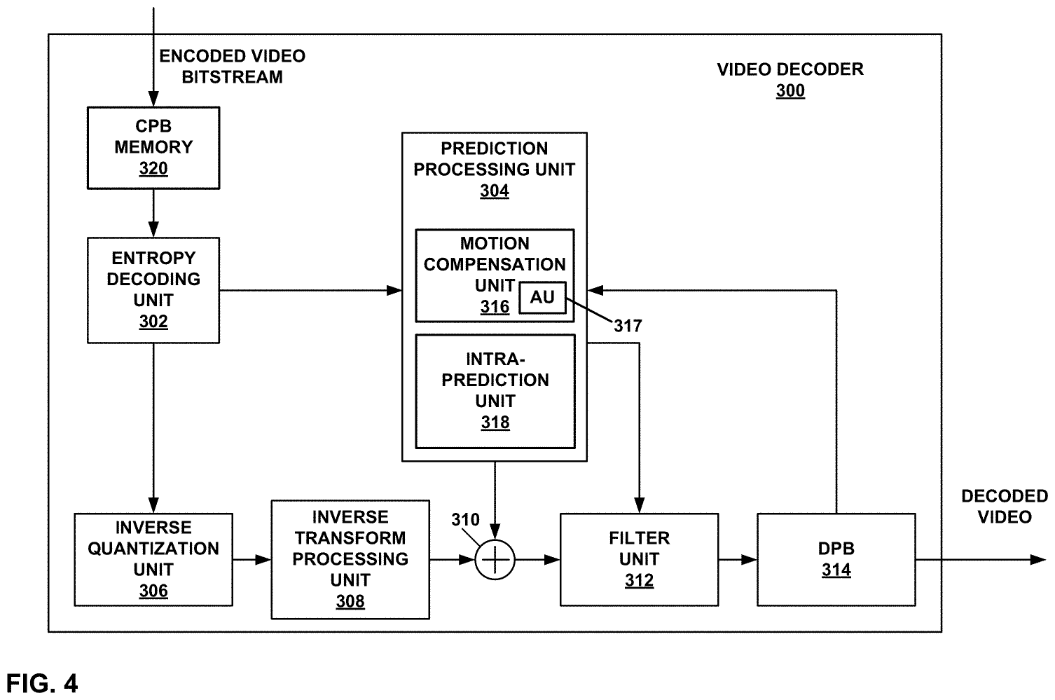

FIG. 4 is a block diagram illustrating an example video decoder 300 that may perform the techniques of this disclosure. FIG. 4 is provided for purposes of explanation and is not limiting on the techniques as broadly exemplified and described in this disclosure. For purposes of explanation, the video decoder 300 is described according to the techniques of JEM, VVC, and HEVC. However, the techniques of this disclosure may be performed by video coding devices that are configured to other video coding standards.

In the example of FIG. 4, the video decoder 300 includes coded picture buffer (CPB) memory 320, entropy decoding unit 302, prediction processing unit 304, inverse quantization unit 306, inverse transform processing unit 308, reconstruction unit 310, filter unit 312, and decoded picture buffer (DPB) 314. Any or all of the CPB memory 320, the entropy decoding unit 302, the prediction processing unit 304, the inverse quantization unit 306, the inverse transform processing unit 308, the reconstruction unit 310, the filter unit 312, and the DPB 314 may be implemented in one or more processors or in processing circuitry. Moreover, the video decoder 300 may include additional or alternative processors or processing circuitry to perform these and other functions.

The prediction processing unit 304 includes motion compensation unit 316 and intra-prediction unit 318. The prediction processing unit 304 may include addition units to perform prediction in accordance with other prediction modes. As examples, the prediction processing unit 304 may include a palette unit, an intra-block copy unit (which may form part of motion compensation unit 316), an affine unit (AU) 317, a linear model (LM) unit, or the like. In other examples, the video decoder 300 may include more, fewer, or different functional components.

The CPB memory 320 may store video data, such as an encoded video bitstream, to be decoded by the components of the video decoder 300. The video data stored in the CPB memory 320 may be obtained, for example, from computer-readable medium 110 (FIG. 1). The CPB memory 320 may include a CPB that stores encoded video data (e.g., syntax elements) from an encoded video bitstream. Also, the CPB memory 320 may store video data other than syntax elements of a coded picture, such as temporary data representing outputs from the various units of the video decoder 300. The DPB 314 generally stores decoded pictures, which the video decoder 300 may output and/or use as reference video data when decoding subsequent data or pictures of the encoded video bitstream. The CPB memory 320 and the DPB 314 may be formed by any of a variety of memory devices, such as dynamic random access memory (DRAM), including synchronous DRAM (SDRAM), magnetoresistive RAM (MRAM), resistive RAM (RRAM), or other types of memory devices. The CPB memory 320 and the DPB 314 may be provided by the same memory device or separate memory devices. In various examples, the CPB memory 320 may be on-chip with other components of the video decoder 300, or off-chip relative to those components.

Additionally or alternatively, in some examples, the video decoder 300 may retrieve coded video data from the memory 120 (FIG. 1). That is, the memory 120 may store data as discussed above with the CPB memory 320. Likewise, the memory 120 may store instructions to be executed by the video decoder 300, when some or all of the functionality of the video decoder 300 is implemented in software to executed by processing circuitry of the video decoder 300.

The various units shown in FIG. 4 are illustrated to assist with understanding the operations performed by the video decoder 300. The units may be implemented as fixed-function circuits, programmable circuits, or a combination thereof. Similar to FIG. 3, fixed-function circuits refer to circuits that provide particular functionality, and are preset on the operations that can be performed. Programmable circuits refer to circuits that can programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, the one or more of the units may be distinct circuit blocks (fixed-function or programmable), and in some examples, the one or more units may be integrated circuits.

The video decoder 300 may include ALUs, EFUs, digital circuits, analog circuits, and/or programmable cores formed from programmable circuits. In examples where the operations of the video decoder 300 are performed by software executing on the programmable circuits, on-chip or off-chip memory may store instructions (e.g., object code) of the software that the video decoder 300 receives and executes.

The entropy decoding unit 302 may receive encoded video data from the CPB and entropy decode the video data to reproduce syntax elements. The prediction processing unit 304, the inverse quantization unit 306, the inverse transform processing unit 308, the reconstruction unit 310, and the filter unit 312 may generate decoded video data based on the syntax elements extracted from the bitstream.

In general, the video decoder 300 reconstructs a picture on a block-by-block basis. The video decoder 300 may perform a reconstruction operation on each block individually (where the block currently being reconstructed, i.e., decoded, may be referred to as a “current block”).

The entropy decoding unit 302 may entropy decode syntax elements defining quantized transform coefficients of a quantized transform coefficient block, as well as transform information, such as a quantization parameter (QP) and/or transform mode indication(s). The inverse quantization unit 306 may use the QP associated with the quantized transform coefficient block to determine a degree of quantization and, likewise, a degree of inverse quantization for the inverse quantization unit 306 to apply. The inverse quantization unit 306 may, for example, perform a bitwise left-shift operation to inverse quantize the quantized transform coefficients. The inverse quantization unit 306 may thereby form a transform coefficient block including transform coefficients.

After the inverse quantization unit 306 forms the transform coefficient block, the inverse transform processing unit 308 may apply one or more inverse transforms to the transform coefficient block to generate a residual block associated with the current block. For example, the inverse transform processing unit 308 may apply an inverse DCT, an inverse integer transform, an inverse Karhunen-Loeve transform (KLT), an inverse rotational transform, an inverse directional transform, or another inverse transform to the coefficient block.

Furthermore, the prediction processing unit 304 generates a prediction block according to prediction information syntax elements, including prediction information syntax elements that were entropy decoded by the entropy decoding unit 302. For example, if the prediction information syntax elements indicate that the current block is inter-predicted, the motion compensation unit 316 may generate the prediction block. In this case, the prediction information syntax elements may indicate a reference picture in the DPB 314 from which to retrieve a reference block, as well as a motion vector identifying a location of the reference block in the reference picture relative to the location of the current block in the current picture. The motion compensation unit 316 may generally perform the inter-prediction process in a manner that is substantially similar to that described with respect to the motion compensation unit 224 (FIG. 3).

As another example, if the prediction information syntax elements indicate that the current block is intra-predicted, the intra-prediction unit 318 may generate the prediction block according to an intra-prediction mode indicated by the prediction information syntax elements. Again, the intra-prediction unit 318 may generally perform the intra-prediction process in a manner that is substantially similar to that described with respect to the intra-prediction unit 226 (FIG. 3). The intra-prediction unit 318 may retrieve data of neighboring samples to the current block from the DPB 314.

In another example, if the prediction information syntax elements indicate that the current block is affine predicted, the affine unit 317 may generate the prediction block according to affine mode. The affine unit 317 may determine delta motion vectors from CPMVs of a neighboring block of a current block of video data, scale the delta motion vectors and clip the delta motion vectors when generating a prediction block for the current block of video data being encoded.

The reconstruction unit 310 may reconstruct the current block using the prediction block and the residual block. For example, the reconstruction unit 310 may add samples of the residual block to corresponding samples of the prediction block to reconstruct the current block.

The filter unit 312 may perform one or more filter operations on reconstructed blocks. For example, the filter unit 312 may perform deblocking operations to reduce blockiness artifacts along edges of the reconstructed blocks. Operations of the filter unit 312 are not necessarily performed in all examples.

The video decoder 300 may store the reconstructed blocks in the DPB 314. As discussed above, the DPB 314 may provide reference information, such as samples of a current picture for intra-prediction and previously decoded pictures for subsequent motion compensation, to the prediction processing unit 304. Moreover, the video decoder 300 may output decoded pictures from DPB for subsequent presentation on a display device, such as the display device 118 of FIG. 1.

In accordance with one or more techniques of this disclosure, video decoder 300 may selectively constrain affine motion inheritance from a neighboring block to use either 4-parameter inheritance or 6-parameter inheritance based on whether the current block and the neighboring block are located in the same VPDU. For instance, where the current block and the neighboring block are located in the same VPDU and the neighboring block is coded using a 6-parameter affine model, the affine unit 317 of video decoder 300 may determine values for CPMVs of the current block based on values of all three CPMVs of the neighboring block (e.g., perform 6-parameter inheritance). However, where the current block and the neighboring block are located in different VPDUs and the neighboring block is coded using a 6-parameter affine model, the affine unit 317 may determine values for CPMVs of the current block based on values of two of the three CPMVs of the neighboring block (e.g., perform 4-parameter inheritance). As such, where the current block and the neighboring block are located in different VPDUs, the affine unit 317 may only need to store values for two of the three motion vectors of the neighboring block. In this way, the techniques of this disclosure enable video decoder 300 to reduce amount of information stored in an inter-VPDU data buffer.

In this manner, the video decoder 300 represents an example of a video decoding device including a memory configured to store video data, and one or more processing units implemented in circuitry and configured to derive, responsive to determining to inherit affine motion information for a current block of video data located in a current virtual pipeline data unit (VPDU) from a neighboring block of video data located in a different VPDU, the affine motion information for the current block from two sub-block motion vectors of the neighboring block of video data; determine, based on the derived affine motion information for the current block of video data, a predictor block of video data; and reconstruct the current block of video data based on the predictor block of video data.

For instance, video decoder 300 may store all subblock motion vectors for a whole VPDU. For regular motion vector prediction, video decoder 300 may store an additional line of subblock motion vectors that are immediate neighbors of current VPDU. Affine motion inheritance from a different VPDU is not constrained, video decoder 300 may have to utilize an extra buffer (e.g., extra storage capacity) to store the third CPMV. On the other hand, by utilizing the techniques of this disclosure and constraining affine motion inheritance from a different VPDU to use only two CPMVs, video decoder 300 may not need that extra buffer, since the selected two CPMVs are already stored in the line of subblock motion vectors anyway. For example, the V_BM and V_RB are already stored for regular motion vector prediction in FIG. 12.

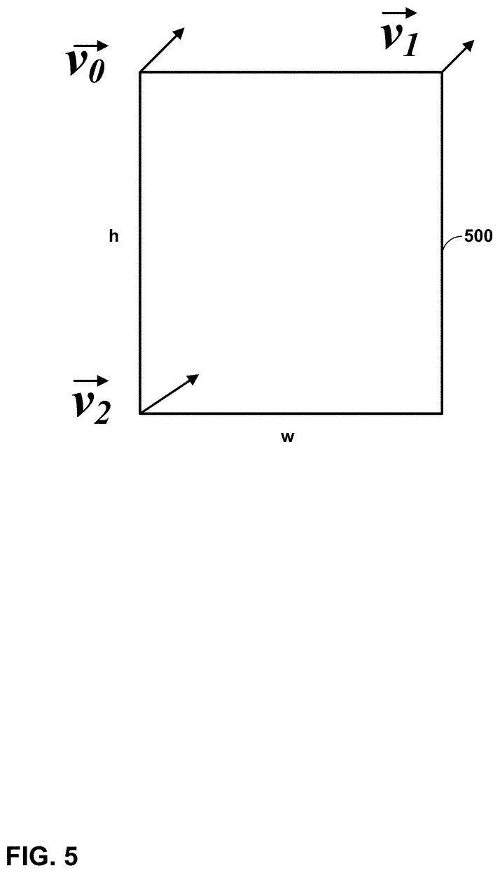

FIG. 5 is a conceptual diagram illustrating control points for a 6-parameter affine motion model. One model of motion prediction is an affine model. As discussed above, a six-parameter affine motion model may be described in accordance with equation (3) where (vₓ, v_{y}) is the motion vector at the coordinate (x, y), and a, b, c, d, e, and f are the six parameters. The affine motion model for a block may also be described by the three motion vectors (MVs) \vec{v}₀=(v₀, v_{0y}), \hat{v}₁=(v₁ₓ, v_{1y}), and \vec{v}₂=(v₂ₓ, v_{2y}) at three corners of the block 500 (sometimes referred to as control point motion vectors), as shown in FIG. 5. As shown in FIG. 5, \vec{v}₀ is at the top-left corner of the block 500, \vec{v}₁ is at the top-right corner of the block 500, and \vec{v}₂ is at the bottom-left corner of the block 500. The motion field is then described in accordance with equation (4) above where w and h are the width and height of the block.

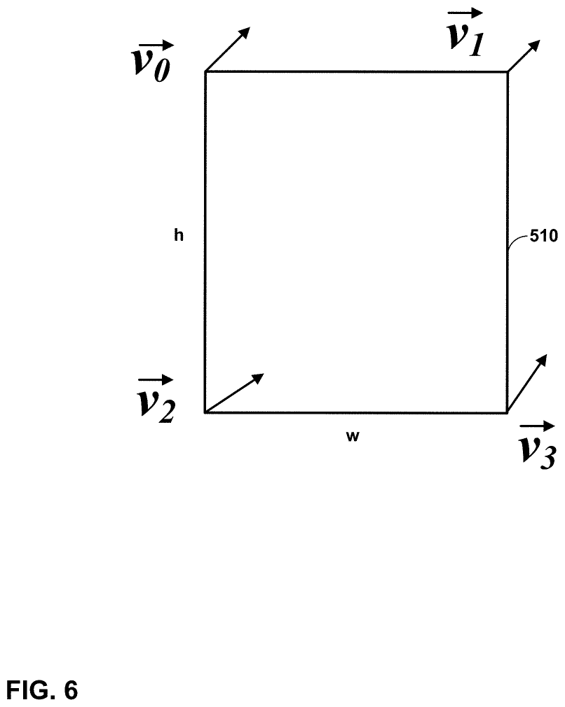

FIG. 6 is a conceptual diagram illustrating another example of control point motion vectors (e.g., \vec{v}₀, \vec{v}₁, \vec{v}₂, \vec{v}₃) for block 510 for an affine motion model. In the following, the MV vi is referred to as a CPMV.

CPMVs are not necessarily the same as in FIG. 5 or in FIG. 6. Other CPMVs selections may also be used. For a 4-parameter affine model, the control point pairs can be selected from any two of the CPMVs {\vec{v}₀, \vec{v}₁, \vec{v}₂, \vec{v}₃}, as shown in FIG. 6. For a 6-parameter affine model, the control point set can be selected from any three of CPMVs. Given the selected CPMVs, the other MV can be calculated by the derived affine motion model.

The affine motion model may also be represented by an anchor MV \vec{v}₀ at coordinate (x₀, y₀), a horizontal delta MV ∇\vec{v}ₕ and a vertical delta MV ∇\vec{v}ᵥ. The MV \vec{v} at the coordinate (x, y) can be calculated as v\vec{v}=\vec{v}₀+x*∇\vec{v}ₕ+y*∇\vec{v}ᵥ.

A CPMV representation can be converted to the representation with delta MVs. For example, \vec{v}₀ is the same as the top-left CPMV, ∇\vec{v}ₕ=(\vec{v}₁−\vec{v}₀)/w, ∇\vec{v}ᵥ=(\vec{v}₂−\vec{v}₀)/h.

Note that the operations described above are vector operations. The addition, division, and multiplication operations are applied element wise.

As in the normal motion vector prediction techniques in HEVC, affine motion predictors can be derived from the CPMVs or normal motion vectors of the neighboring coded blocks. Example types of affine motion predictors include inherited affine motion vector predictors and constructed affine motion vector predictors.

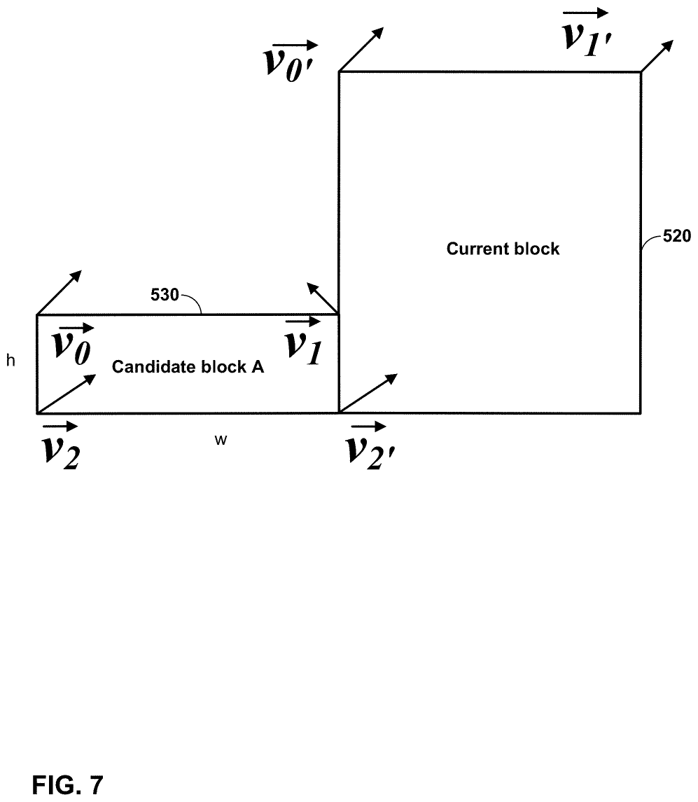

When obtaining an inherited affine motion vector predictor (MVP), the video encoder 200 and the video decoder 300 may be configured to use the affine motion of a neighboring coded block to derive the predicted CPMVs of current block. This process operates under the assumption that the current block shares the same affine motion model as the neighboring coded block. In this context, the neighboring coded block is referred to as a candidate block. The candidate block may be selected from different spatial or temporal neighboring locations. An example is shown in FIG. 7. The CPMVs of the neighboring candidate block A 530 in FIG. 7 (represented as the motion vectors at the control-points) are: \vec{v}0\vec{v}=(\vec{v}₀ₓ, \vec{v}_{0y}), \vec{v}₁=(v₁ₓ, v_{1y}), \vec{v}₂=(v₂ₓ, v_{2y}), the size of candidate block A 530 is (w, h), and the coordinates of control points of the neighboring candidate block A 530 are (x0, y0), (x1, y1), and (x2, y2). The predicted CPMVs \vec{v}₀′=(v₀ₓ′, v_{0y}′). \vec{v}₀′=(v₁ₓ′, v_{1y}′), \vec{v}₂′=(v₂ₓ′, v_{2y}′) at the control points of the current block 520 can be derived by replacing (x,y) in equation (2) with the coordinate difference between the control points of current block 520 and the top-left control point of neighboring candidate block A 530, such that:

$$\begin{matrix}\{ \begin{matrix}{v}_{0 x}^{′} = \frac{( {v}_{1 x} - {v}_{0 x} )}{w} ( x {0}^{′} - x 0 ) + \frac{( {v}_{2 x} - {v}_{0 x} )}{h} ( y {0}^{′} - y 0 ) + {v}_{0 x} \\ {v}_{0 y}^{′} = \frac{( {v}_{1 y} - {v}_{0 y} )}{w} ( x {0}^{′} - x 0 ) + \frac{( {v}_{2 y} - {v}_{0 y} )}{h} ( y {0}^{′} - y 0 ) + {v}_{0 y}\end{matrix} & ( 5 ) \\ \{ \begin{matrix}{v}_{1 x}^{′} = \frac{( {v}_{1 x} - {v}_{0 x} )}{w} ( x {1}^{′} - x 0 ) + \frac{( {v}_{2 x} - {v}_{0 x} )}{h} ( y {1}^{′} - y 0 ) + {v}_{0 x} \\ {v}_{1 y}^{′} = \frac{( {v}_{1 y} - {v}_{0 y} )}{w} ( x {1}^{′} - x 0 ) + \frac{( {v}_{2 y} - {v}_{0 y} )}{h} ( y {1}^{′} - y 0 ) + {v}_{0 y}\end{matrix} & ( 6 ) \\ \{ \begin{matrix}{v}_{2 x}^{′} = \frac{( {v}_{1 x} - {v}_{0 x} )}{w} ( x {2}^{′} - x 0 ) + \frac{( {v}_{2 x} - {v}_{0 x} )}{h} ( y {2}^{′} - y 0 ) + {v}_{0 x} \\ {v}_{2 y}^{′} = \frac{( {v}_{1 y} - {v}_{0 y} )}{w} ( x {2}^{′} - x 0 ) + \frac{( {v}_{2 y} - {v}_{0 y} )}{h} ( y {2}^{′} - y 0 ) + {v}_{0 y}\end{matrix} & ( 7 )\end{matrix}$$

wherein (x0′, y0′), (x1′, y1′), and (x2′, y2′) are the coordinates of control-points in current block. If represented as delta MVs, \vec{v}₀′=v₀ₓ+(x0′−x0)*∇\vec{v}ₕ+(y0′−y0)*∇\vec{v}ᵥ, \vec{v}₁′=v₀ₓ+(x1′−x0)*∇\vec{v}ₕ+(y1′−y0)*∇\vec{v}ᵥ, \vec{v}₂′=v₀ₓ+(x2′−x0)*∇\vec{v}ₕ+(y2′−y0)*∇\vec{v}ᵥ.

Similarly, if the neighboring candidate block's affine model is 4-parameter affine model, then the equation (4) is applied. If the affine model for the current block is 4-parameter affine model, then equation (7) can be ignored.

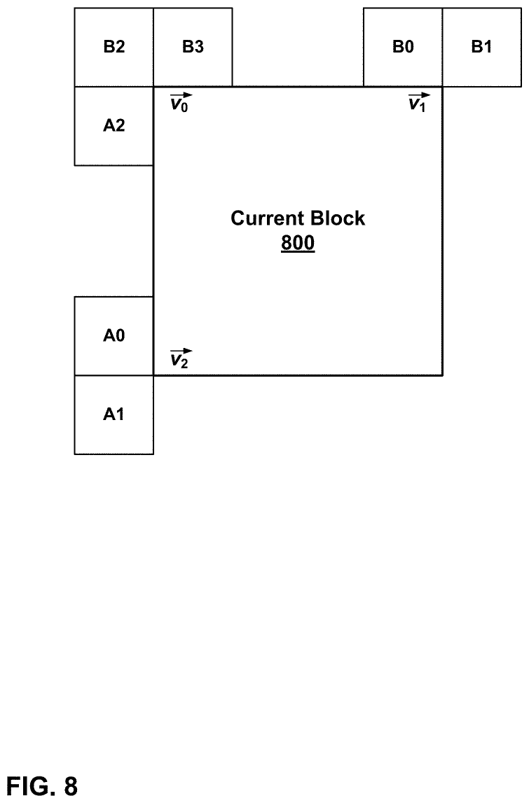

FIG. 8 is a conceptual diagram illustrating example candidate blocks. In one example, the candidate block can be located at locations A0, B0, B1, A1, B2, as shown in FIG. 8.

A constructed affine motion vector predictor is derived by predicting the motion vectors at the control points of the current block as the normal motion vector prediction. In other words, the video encoder 200 or the video decoder 300 may derive the constrained affine motion vector predictor in a similar manner to the manner the video encoder 200 or the video decoder 300 would derive an affine motion vector predictor. For example, as shown in FIG. 8, the motion vector \vec{v}₀ at the top-left control point can be predicted by the motion vector at B2, B3 or A3, the motion vector \vec{v}₂ at the top-right control point can be predicted by the motion vector at B0 or B1, and the motion vector \vec{v}₂ at the left-bottom control point can be predicted by the motion vector at A0 or A1.

Virtual pipeline data units (VPDUs) may be defined as non-overlapping M×M-luma (L)/N×N-chroma (C) units in a picture. In hardware decoders, successive VPDUs may be processed by multiple pipeline stages at the same time; different stages may process different VPDUs simultaneously. As the VPDU size may be roughly proportional to the buffer size in most pipeline stages, it may be desirable to keep the VPDU size small. In HEVC hardware decoders, the VPDU size is set to maximum transform block (TB) size. Enlarging maximum TB size from 32×32-L/16×16-C (as in HEVC) to 64×64-L/32×32-C (as in VVC draft 4) can bring coding gains, which results in 4× of VPDU size (64×64-L/32×32-C) expectedly in comparison with HEVC. However, in addition to quadtree (QT) coding unit (CU) partitioning, ternary tree (TT) and binary tree (BT) are adopted in VVC draft 4 for achieving additional coding gains. TT and BT splits can be applied to 128×128-L/64×64-C coding tree blocks (CTUs) recursively, which leads to 16× of VPDU size (128×128-L/64×64-C) in comparison with HEVC. To reduce the VPDU size in VVC draft 4, the VPDU size is defined as 64×64-L/32×32-C and satisfies the following two conditions, and the processing order of CUs shall not leave a VPDU and re-visit it later.

Condition 1: For each VPDU containing one or multiple CUs, the CUs are completely contained in the VPDU.

Condition 2: For each CU containing one or more VPDUs, the VPDUs are completely contained in the CU.

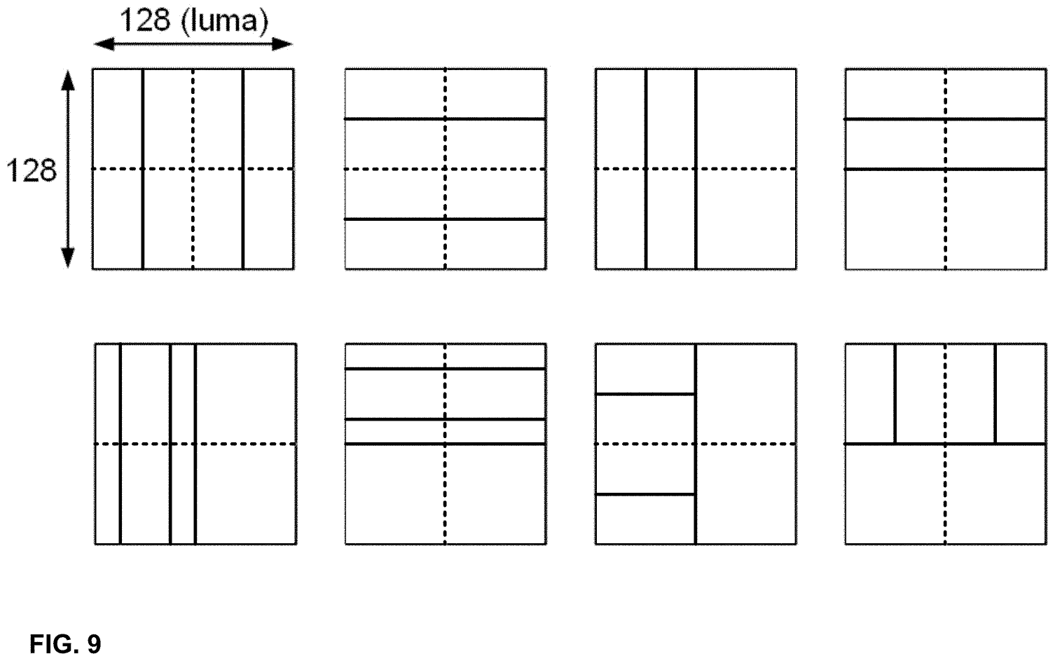

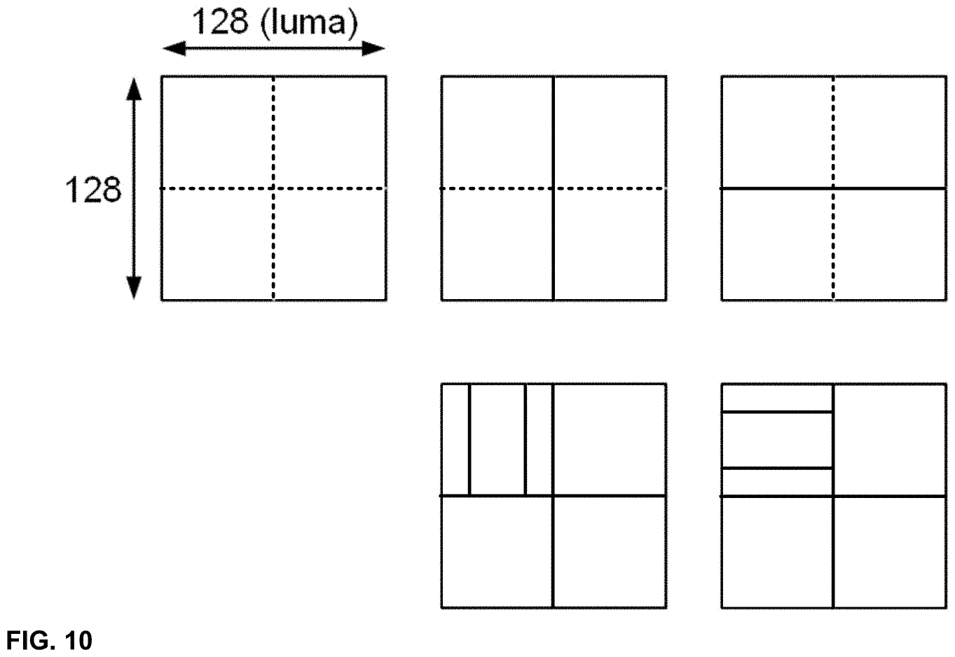

Examples of undesirable TT and BT splits for 64×64-L/32×32-C pipelining are shown in FIG. 9. Examples of allowed TT and BT splits for 64×64-L/32×32-C pipelining (VPDUs indicated by dashed lines) are shown in FIG. 10.

In accordance with one or more techniques of this disclosure, a video coder (e.g., video encoder 200 and/or video decoder 300) may constrain affine motion inheritance for a current block in a current VPDU from neighboring blocks that are outside a current VPDU. For instance, if the neighboring block (e.g., from which affine motion parameters of a current block are to be inherited/derived) is located outside of a current VPDU and coded using 6-parameter affine mode, the video coder may perform the affine inheritance as 4-parameter affine motion inheritance (e.g., affine inheritance may be degraded to 4-parameter affine motion inheritance if the neighboring block is coded using 6-parameter affine mode). As such, the video coder may utilize two subblock motion vectors from the neighboring block for the affine motion inheritance of the current block.

In some examples, the video coder may only apply the constraint where the neighboring block is from the above VPDU (i.e., a VPDU located above the current VPDU). In some examples, the video coder may only apply the constraint where the neighboring block is from the left VPDU (i.e., a VPDU located to the left of the current VPDU). In some examples, the video coder may only apply the constraint where the neighboring block is from the left or above VPDU.

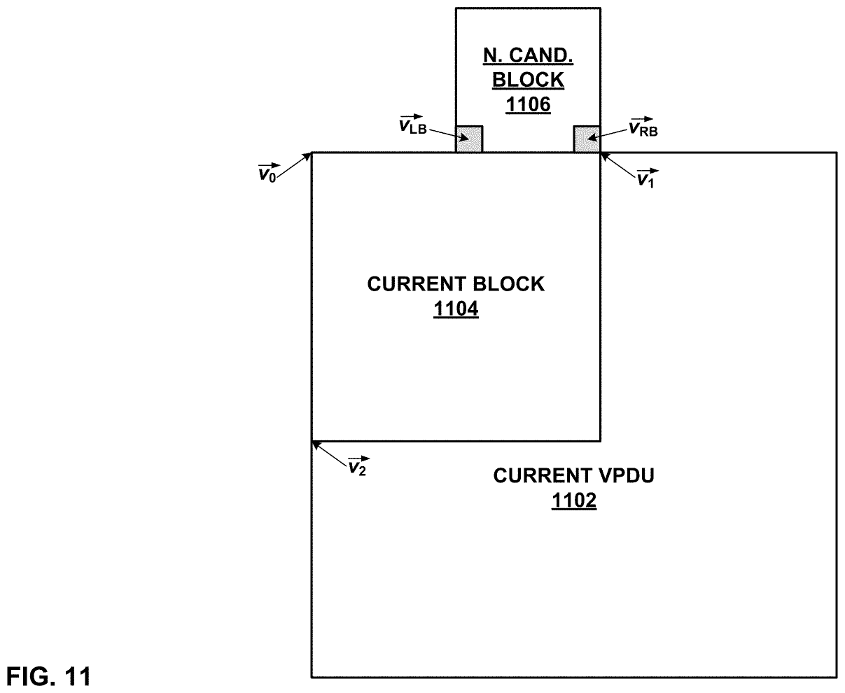

FIG. 11 is a conceptual diagram illustrating constrained affine inheritance, in accordance with one or more techniques of this disclosure. As shown in FIG. 11, a current VPDU 1102 includes a current block 1104 and an above VPDU includes a neighboring candidate block 1106. In the example of FIG. 11, a video coder may use the subblock motion vectors at the bottom-left (e.g., \vec{v}_{LB}) and bottom-right (e.g., \vec{v}_{RB}) of the neighboring block 1106 to derive the control motion vectors or affine motion parameters of the current block 1104 (e.g., \vec{v}₀, \vec{v}₁, \vec{v}₂), assuming that the neighboring block is 4-parameter affine model.

FIG. 12 is a conceptual diagram illustrating constrained affine inheritance, in accordance with one or more techniques of this disclosure. As shown in FIG. 12, a current VPDU 1202 includes a current block 1204 and an above VPDU includes a neighboring candidate block 1206. In the example of FIG. 12, a video coder may use the subblock motion vectors at the bottom-middle (e.g., \vec{v}_{BM}) and bottom-right (e.g., \vec{v}_{RB}) of the neighboring block 1206 to derive the control motion vectors or affine motion parameters of the current block 1204 (e.g., \vec{v}₀, \vec{v}₁, \vec{v}₂), assuming that the neighboring block is 4-parameter affine model.

Similarly, where the neighboring block is located in a left VPDU, the video coder may derive the control motion vectors or affine motion parameters of the current block from the top-right and bottom-right subblock MVs of the neighboring block or the middle-right and bottom-right of the subblock MVs of the neighboring block. For example, affine motion inheritance from the left VPDU can be derived from the top-right and bottom-right subblock MVs of the neighboring block or the middle-right and bottom-right of the subblock MVs of the neighboring block.

The following are two examples of derivation processes for luma affine control point motion vectors from a neighbouring block. These examples are presented in the context of VVC draft 4 (e.g., JVET-M1001).

### Example 1

Example of Derivation process for luma affine control point motion vectors from a neighbouring block

```
Inputs to this process are:
  a luma location ( xCb, yCb ) specifying the top-left sample of the current luma coding block
  relative to the top-left luma sample of the current picture,
  two variables cbWidth and cbHeight specifying the width and the height of the current luma
  coding block,
  a luma location ( xNb, yNb ) specifying the top-left sample of the neighbouring luma coding
  block relative to the top-left luma sample of the current picture,
  two variables nNbW and nNbH specifying the width and the height of the neighbouring luma
  coding block,
  the number of control point motion vectors numCpMv.
Output of this process are the luma affine control point vectors cpMvLX[ cpIdx ] with
cpIdx = 0 . . . numCpMv − 1 and X being 0 or 1.
The variable isVPDUAboveboundary is derived as follows:
  If the following condition is true, isVPDUAboveboundary is set equal to TRUE:
    ( yNb >> log2MaxTuSize ) is less than ( yCb >> log2MaxTuSize)
  Otherwise, isVPDUAboveboundary is set equal to FALSE.
The variables log2NbHalfW and log2NbHalfH are derived as follows:
    log2NbHalfW = Log2( nNbW/2 )
    log2NbHalfH = Log2( nNbH /2)
The variables mvScaleHor, mvScaleVer, are derived as follows:
  mvScaleHor = MvLX[ xNb + nNbW − 1 ][ yNb + nNbH − 1 ][ 0 ] << 7
  mvScaleVer = MvLX[ xNb + nNbW − 1 ][ yNb + nNbH − 1 ][ 1 ] << 7
The variables dHorX and dVerX are derived as follows:
  dHorX = ( MvLX[ xNb + nNbW − 1 ][ yNb + nNbH − 1 ][ 0 ] − MvLX[ xNb +
  nNbW/2 − 1 ][ yNb + nNbH − 1 ][ 0] ) <<
    ( 7 − log2NbHalfW)
  dVerX = ( MvLX[ xNb + nNbW − 1 ][ yNb + nNbH − 1 ][ 1 ] − MvLX[ xNb +
  nNbW/2 − 1][ yNb + nNbH − 1 ][ 1] ) <<
    ( 7 − log2NbHalfW)
The variables dHorY and dVerY are derived as follows:
  If isVPDUAboveboundary is equal to FALSE and MotionModelIdc[ xNb ][ yNb ] is equal to 2,
  the following applies:
    dHorY = ( CpMvLX[ xNb + nNbW − 1 ][ yNb + nNbH − 1 ][ 2 ][ 0 ] − CpMvLX[ xNb +
    nNbW − 1 ][ yNb + nNbH/2 − 1 ][ 2 ][ 0 ] ) <<
      ( 7 − log2NbHalfH)
    dVerY = ( CpMvLX[ xNb + nNbW − 1 ][ yNb + nNbH − 1 ][ 2 ][ 1 ] − CpMvLX[ xNb +
    nNbW − 1 ][ yNb + nNbH/2 − 1 ][ 2 ][ 1 ] ) <<
      ( 7 − log2NbHalfH)
  Otherwise (isCTUboundary is equal to TRUE or MotionModelIdc[ xNb ][ yNb ] is equal to 1),
the following applies,
        dHorY = −dVerX
        dVerY = dHorX
```

### Example 2

Another example of Derivation process for luma affine control point motion vectors from a neighbouring block

```
Inputs to this process are:
  a luma location ( xCb, yCb ) specifying the top-left sample of the current luma coding block
  relative to the top-left luma sample of the current picture,
  two variables cbWidth and cbHeight specifying the width and the height of the current luma
  coding block,
  a luma location ( xNb, yNb ) specifying the top-left sample of the neighbouring luma coding
  block relative to the top-left luma sample of the current picture,
  two variables nNbW and nNbH specifying the width and the height of the neighbouring luma
  coding block,
  the number of control point motion vectors numCpMv.
Output of this process are the luma affine control point vectors cpMvLX[ cpIdx ] with
cpIdx = 0 . . . numCpMv − 1 and X being 0 or 1.
The variable isVPDUAboveboundary is derived as follows:
  If the following condition is true, isVPDUAboveboundary is set equal to TRUE:
    ( yNb >> log2MaxTuSize ) is less than ( yCb >> log2MaxTuSize)
  Otherwise, isVPDUAboveboundary is set equal to FALSE.
The variable isVPDULeftboundary is derived as follows:
  If the following condition is true, isVPDULeftboundary is set equal to TRUE:
    ( xNb >> log2MaxTuSize ) is less than ( xCb >> log2MaxTuSize)
  Otherwise, isVPDULeftboundary is set equal to FALSE.
The variables log2NbHalfW and log2NbHalfH are derived as follows:
    log2NbHalfW = Log2( nNbW/2 )
    log2NbHalfH = Log2( nNbH /2)
The variables mvScaleHor, mvScaleVer, are derived as follows:
  mvScaleHor = MvLX[ xNb + nNbW − 1 ][ yNb + nNbH − 1 ][ 0 ] << 7
  mvScaleVer = MnLX[ xNb + nNbW − 1 ][ yNb + nNbH − 1 ][ 1 ] << 7
If the variable isVPDULeftboundary is equal to TRUE, the following applies:
    The variables dHorX and dVerX are derived as follows:
      dHorY = ( CpMvLX[ xNb + nNbW − 1 ][ yNb + nNbH − 1 ][ 2 ][ 0 ] − CpMvLX[ xNb +
      nNbW − 1 ][ yNb + nNbH/2 − 1 ][ 2 ][ 0 ] ) <<
      ( 7 − log2NbHalfH)
  dVerY = ( CpMvLX[ xNb + nNbW − 1 ][ yNb + nNbH − 1 ][ 2 ][ 1 ] − CpMvLX [ xNb +
nNbW − 1][ yNb + nNbH/2 − 1][ 2 ][ 1 ] ) <<
  ( 7 − log2NbHalfH )
    The variables dHorX and dVerX are derived as follows:
          dVerX = −dHorY
        dHorX = dVerY
Otherwise the following applies:
  The variables dHorX and dVerX are derived as follows:
    dHorX = ( MvLX[ xNb + nNbW − 1 ][ yNb + nNbH − 1 ][ 0 ] − MvLX[ xNb +
    nNbW/2 − 1 ][ yNb + nNbH − 1 ][ 0 ] ) <<
      ( 7 − log2NbHalfW )
    dVerX = ( MvLX[ xNb + nNbW − 1 ][ yNb + nNbH − 1 ][ 1 ] − MvLX[ xNb +
    nNbW/2 − 1 ][ yNb + nNbH − 1 ][ 1 ] ) <<
      ( 7 − log2NbHalfW )
  The variables dHorY and dVerY are derived as follows:
    If isVPDUAboveboundary is equal to FALSE and MotionModelIdc[ xNb ][ yNb ] is equal
    to 2, the following applies:
      dHorY = ( CpMvLX[ xNb + nNbW − 1 ][ yNb + nNbH − 1 ][ 2 ][ 0 ] −
      CpMvLX[ xNb + nNbW − 1 ][ yNb + nNbH/2 − 1 ][ 2 ][ 0 ] ) <<
      ( 7 − log2NbHalfH )
      dVerY = ( CpMvLX[ xNb + nNbW − 1 ][ yNb + nNbH − 1 ][ 2 ][ 1 ] −
      CpMvLX[ xNb + nNbW − 1 ][ yNb + nNbH/2 − 1 ][ 2 ][ 1 ] ) <<
      ( 7 − log2NbHalfH )
    Otherwise (isCTUboundary is equal to TRUE or MotionModelIdc[ xNb ][ yNb ] is equal to
    1), the following applies,
          dHorY = −dVerX
        dVerY = dHorX
```

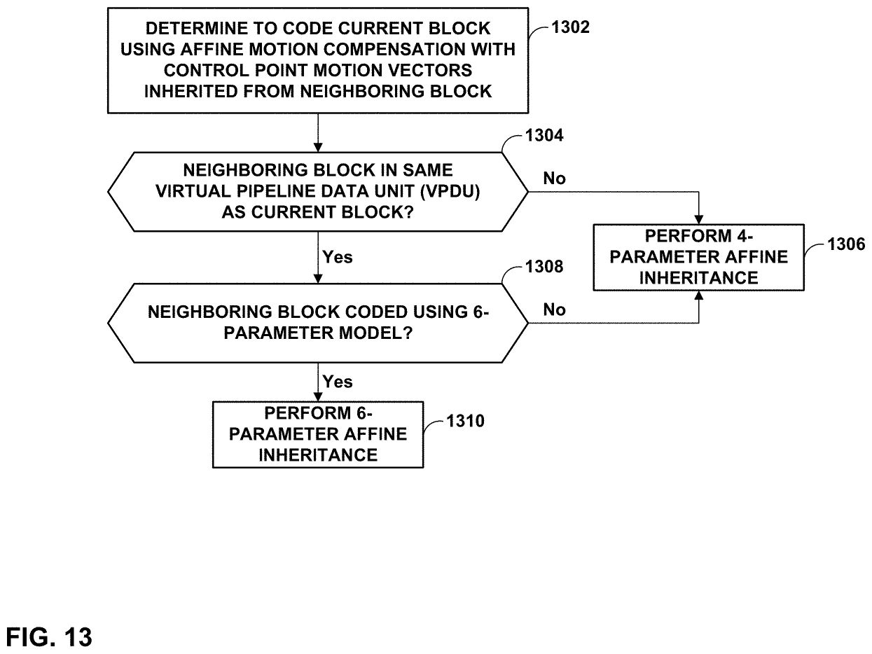

FIG. 13 is a flowchart illustrating an example method for coding a current block using affine motion compensation, in accordance with one or more aspects of this disclosure. The current block may comprise a current CU. The method of FIG. 13 may be performed by a video coder, such as video encoder 200 (FIGS. 1 and 3) and/or video decoder 300 (FIGS. 1 and 4), it should be understood that other devices may be configured to perform a method similar to that of FIG. 13.

In accordance with one or more techniques of this disclosure, responsive to determining to inherit affine motion information for a current block of video data located in a current virtual pipeline data unit (VPDU) from a neighboring block of video data located in a different VPDU, a video coder may derive the affine motion information for the current block from two motion vectors of the neighboring block of video data regardless of whether the neighboring block of video data is coded with a 4-parameter affine model or a 6-parameter affine model.

A video coder may determine to code a current block using affine motion compensation with control point motion vectors (CPMVs) inherited from a neighboring block of video data (1302). The current block of video data may be located in a current virtual pipeline data unit (VPDU). Where the video coder is a video encoder (e.g., video encoder 200), the video coder may determine the code the current block using affine motion compensation by testing several compensation techniques and selecting the technique with the best rate-distortion characteristics. Where the video coder is a video decoder (e.g., video decoder 300), the video coder may determine to code the current block using affine motion compensation based on values of one or more syntax elements included in a video bitstream.

The video coder may alter the CPMV inheritance based on whether the neighboring block is located in the same VPDU as the current block. For instance, responsive to determining that the neighboring block is not located in the same VPDU as the current block (i.e., that the neighboring block is located in a different VPDU than the current block) (“No” branch of 1304), the video coder may perform 4-parameter affine inheritance (e.g., regardless of whether the neighboring block of video data is coded with a 4-parameter affine model or a 6-parameter affine model) (1306).

However, responsive to determining that the neighboring block is located in the same VPDU as the current block (“Yes” branch of 1304), the video coder may perform 4-parameter affine inheritance or 6-parameter affine inheritance based on whether the neighboring block is coded with a 4-parameter affine model or a 6-parameter affine model. For instance, responsive to determining that the neighboring block is coded with a 6-parameter affine model (“Yes” branch of 1308), the video coder may perform 6-parameter affine inheritance (1310). On the other hand, responsive to determining that the neighboring block is not coded with a 6-parameter affine model (i.e., that the neighboring block is coded with a 4-parameter affine model) (“No” branch of 1308), the video coder may perform 4-parameter affine inheritance (1306).

As discussed above, to perform 6-parameter inheritance, the video coder may determine values of CPMVs for the current block based on values of three CPMVs of the neighboring block. For example, the video coder may perform 6-parameter inheritance to determine values of three CPMVs for the current block in accordance with equations (5)-(7). To perform 4-parameter inheritance, the video coder may determine values of CPMVs for the current block based on values of two CPMVs of the neighboring block. For example, the video coder may perform 4-parameter inheritance to determine values of two CPMVs for the current block in accordance with equations (5) and (6).

As such, where the current block and the neighboring block are located in different VPDUs, the video coder may only need to store values for two of the three motion vectors of the neighboring block. In this way, the techniques of this disclosure enable a video coder to reduce amount of information stored in the inter-VPDU data buffer.

The video coder may determine, based on the derived affine motion information for the current block of video data, a predictor block of video data. For instance, the video coder may obtain values of samples of a block of video data identified by the CPMVs of the current block of video data. The video coder may reconstruct the current block of video data based on the predictor block of video data. For instance, the video coder may add residual data to the samples of the predictor block of video data to obtain reconstructed samples of the current block of video data.

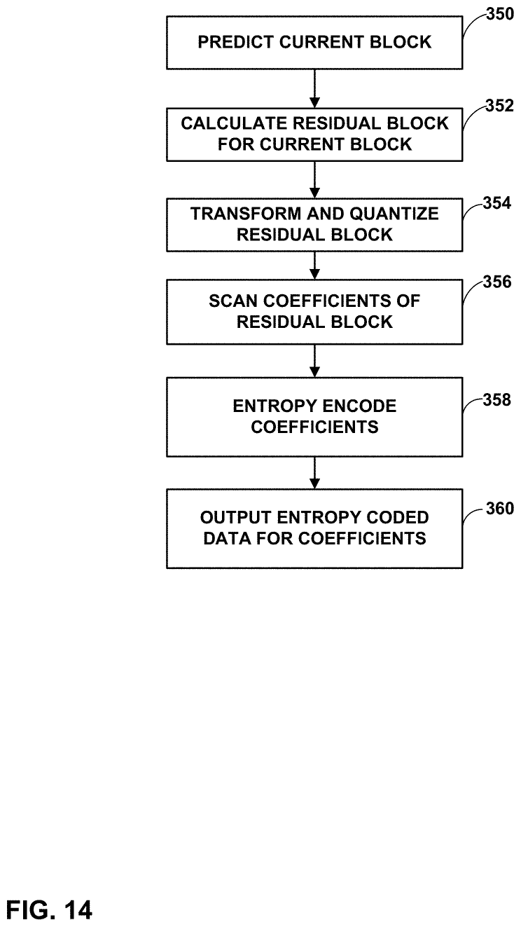

FIG. 14 is a flowchart illustrating an example method for encoding a current block. The current block may comprise a current CU. Although described with respect to video encoder 200 (FIGS. 1 and 2), it should be understood that other devices may be configured to perform a method similar to that of FIG. 14.

In this example, video encoder 200 initially predicts the current block (350). For example, video encoder 200 may form a prediction block for the current block. Video encoder 200 may then calculate a residual block for the current block (352). To calculate the residual block, video encoder 200 may calculate a difference between the original, uncoded block and the prediction block for the current block. Video encoder 200 may then transform and quantize coefficients of the residual block (354). Next, video encoder 200 may scan the quantized transform coefficients of the residual block (356). During the scan, or following the scan, video encoder 200 may entropy encode the coefficients (358). For example, video encoder 200 may encode the coefficients using CAVLC or CABAC. Video encoder 200 may then output the entropy coded data of the block (360).

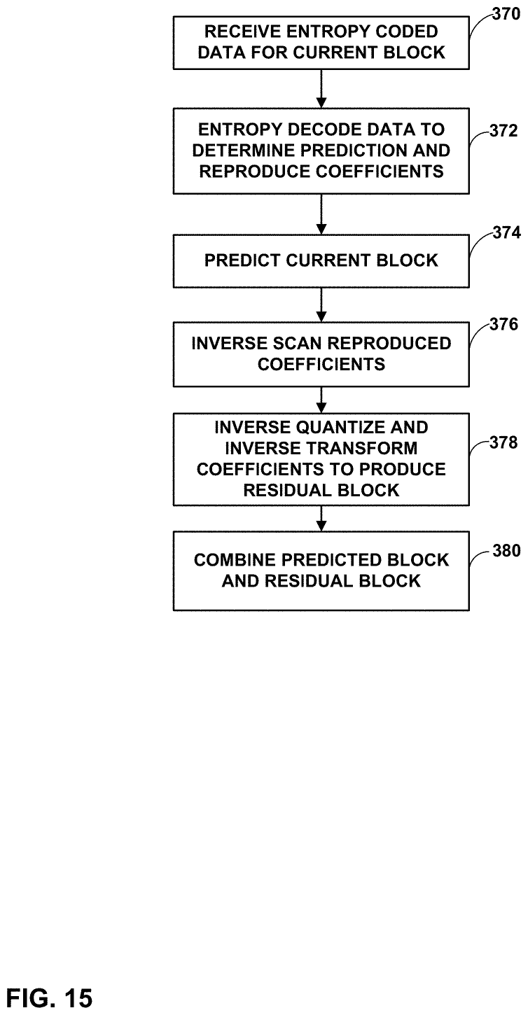

FIG. 15 is a flowchart illustrating an example method for decoding a current block of video data. The current block may comprise a current CU. Although described with respect to video decoder 300 (FIGS. 1 and 3), it should be understood that other devices may be configured to perform a method similar to that of FIG. 15.

Video decoder 300 may receive entropy coded data for the current block, such as entropy coded prediction information and entropy coded data for coefficients of a residual block corresponding to the current block (370). Video decoder 300 may entropy decode the entropy coded data to determine prediction information for the current block and to reproduce coefficients of the residual block (372). Video decoder 300 may predict the current block (374), e.g., using an intra- or inter-prediction mode as indicated by the prediction information for the current block, to calculate a prediction block for the current block. Video decoder 300 may then inverse scan the reproduced coefficients (376), to create a block of quantized transform coefficients. Video decoder 300 may then inverse quantize and inverse transform the coefficients to produce a residual block (378). Video decoder 300 may ultimately decode the current block by combining the prediction block and the residual block (380).

The following numbered examples may illustrate one or more aspects of the disclosure:

### Example 1

A method of coding video data, the method comprising: responsive to determining to inherit affine motion information for a current block of video data located in a current virtual pipeline data unit (VPDU) from a neighboring block of video data located in a different VPDU, deriving the affine motion information for the current block from two motion vectors of the neighboring block of video data regardless of whether the neighboring block of video data is coded with a 4-parameter affine model or a 6-parameter affine model; determining, based on the derived affine motion information for the current block of video data, a predictor block of video data; and reconstructing the current block of video data based on the predictor block of video data.

### Example 2

The method of example 1, wherein the affine motion information for the current block of video data comprises control point motion vectors (CPMVs).

### Example 3

The method of any of examples 1 or 2, wherein the neighboring block is coded with a 6-parameter affine model represented by three CPMVs and is located in a different VPDU than the current block, and wherein deriving the affine motion information for the current comprises deriving a 6-parameter affine motion model of the current block based on two CPMVs of the 6-parameter affine motion model of the neighboring block.

### Example 4

The method of any of examples 1-3, wherein the neighboring block is coded with a 6-parameter affine model represented by three CPMVs and is located in a different VPDU than the current block, and wherein deriving the affine motion information for the current comprises deriving a 4-parameter affine motion model of the current block based on two CPMVs of the 6-parameter affine motion model of the neighboring block.

### Example 5

The method of any of examples 1-4, wherein the neighboring block is coded with a 6-parameter affine model represented by three CPMVs and is located in a same VPDU as the current block, and wherein deriving the affine motion information for the current comprises deriving a 6-parameter affine motion model of the current block based on three CPMVs of the 6-parameter affine motion model of the neighboring block.

### Example 6

The method of any of examples 1-5, wherein the neighboring block is coded with a 6-parameter affine model represented by three CPMVs and is located in a same VPDU as the current block, and wherein deriving the affine motion information for the current comprises deriving a 6-parameter affine motion model of the current block based on three CPMVs of the 6-parameter affine motion model of the neighboring block.

### Example 7

The method of any of examples 1-6, wherein coding comprises decoding.

### Example 8

The method of any of examples 1-7, wherein coding comprises encoding.

### Example 9

A device for coding video data, the device comprising: a memory to store the video data; and one or more processors implemented in circuitry and configured to: derive, responsive to determining to inherit affine motion information for a current block of video data located in a current virtual pipeline data unit (VPDU) from a neighboring block of video data located in a different VPDU, the affine motion information for the current block from two motion vectors of the neighboring block of video data regardless of whether the neighboring block of video data is coded with a 4-parameter affine model or a 6-parameter affine model; determine, based on the derived affine motion information for the current block of video data, a predictor block of video data; and reconstruct the current block of video data based on the predictor block of video data.

### Example 10

The device of example 9, wherein the affine motion information for the current block of video data comprises control point motion vectors (CPMVs).

### Example 11

The device of any of examples 9 or 10, wherein the neighboring block is coded with a 6-parameter affine model represented by three CPMVs and is located in a different VPDU than the current block, and wherein deriving the affine motion information for the current comprises deriving a 6-parameter affine motion model of the current block based on two CPMVs of the 6-parameter affine motion model of the neighboring block.

### Example 12

The device of any of examples 9-11, wherein the neighboring block is coded with a 6-parameter affine model represented by three CPMVs and is located in a different VPDU than the current block, and wherein deriving the affine motion information for the current comprises deriving a 4-parameter affine motion model of the current block based on two CPMVs of the 6-parameter affine motion model of the neighboring block.

### Example 13

The device of any of examples 9-12, wherein the neighboring block is coded with a 6-parameter affine model represented by three CPMVs and is located in a same VPDU as the current block, and wherein deriving the affine motion information for the current comprises deriving a 6-parameter affine motion model of the current block based on three CPMVs of the 6-parameter affine motion model of the neighboring block.

### Example 14

The device of any of examples 9-13, wherein the neighboring block is coded with a 6-parameter affine model represented by three CPMVs and is located in a same VPDU as the current block, and wherein deriving the affine motion information for the current comprises deriving a 6-parameter affine motion model of the current block based on three CPMVs of the 6-parameter affine motion model of the neighboring block.

### Example 15

The device of any of examples 9-14, wherein the device comprises a video decoder.

### Example 16

The device of any of examples 9-15, wherein the device comprises a video encoder.

### Example 17

The device of any of examples 9-16, further comprising a display configured to display decoded video data.

### Example 18

The device of any of examples 9-17, wherein the device comprises one or more of a camera, a computer, a mobile device, a broadcast receiver device, or a set-top box.

### Example 19

A computer-readable storage medium having stored thereon instructions that, when executed, cause one or more processors to: derive, responsive to determining to inherit affine motion information for a current block of video data located in a current virtual pipeline data unit (VPDU) from a neighboring block of video data located in a different VPDU, the affine motion information for the current block from two motion vectors of the neighboring block of video data regardless of whether the neighboring block of video data is coded with a 4-parameter affine model or a 6-parameter affine model; determine, based on the derived affine motion information for the current block of video data, a predictor block of video data; and reconstruct the current block of video data based on the predictor block of video data.

### Example 20

The computer-readable storage medium of example 19, further storing instructions that cause the one or more processors to: retain, after coding the different VPDU that includes the neighboring block of video data, only a subset of the affine motion information of the neighboring block of video data.

### Example 21

A device comprising means for performing the method of any combination of examples 1-8.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A device for coding video data, the device comprising:
a memory to store the video data; and
one or more processors implemented in circuitry and configured to:
derive, responsive to determining to inherit affine motion information for a current block of video data located in a current virtual pipeline data unit (VPDU) from a neighboring block of video data located in a different VPDU, the affine motion information for the current block from two motion vectors of the neighboring block of video data regardless of whether the neighboring block of video data is coded with a 4-parameter affine model or a 6-parameter affine model;
determine, based on the derived affine motion information for the current block of video data, a predictor block of video data; and
reconstruct the current block of video data based on the predictor block of video data.

2. The device of claim 1, wherein the affine motion information for the current block of video data comprises control point motion vectors (CPMVs).

3. The device of claim 1, wherein the neighboring block is coded with a 6-parameter affine model represented by three control point motion vectors (CPMVs) and is located in a different VPDU than the current block, and wherein, to derive the affine motion information for the current, the one or more processors are configured to derive a 6-parameter affine motion model of the current block based on two CPMVs of the 6-parameter affine motion model of the neighboring block.

4. The device of claim 1, wherein the neighboring block is coded with a 6-parameter affine model represented by three control point motion vectors (CPMVs) and is located in a different VPDU than the current block, and wherein, to derive the affine motion information for the current, the one or more processors are configured to derive a 4-parameter affine motion model of the current block based on two CPMVs of the 6-parameter affine motion model of the neighboring block.

5. The device of claim 1, wherein the neighboring block is coded with a 6-parameter affine model represented by three control point motion vectors (CPMVs) and is located in a same VPDU as the current block, and wherein, to derive the affine motion information for the current, the one or more processors are configured to derive a 6-parameter affine motion model of the current block based on three CPMVs of the 6-parameter affine motion model of the neighboring block.

6. The device of claim 1, wherein the neighboring block is coded with a 6-parameter affine model represented by three control point motion vectors (CPMVs) and is located in a same VPDU as the current block, and wherein, to derive the affine motion information for the current, the one or more processors are configured to derive a 6-parameter affine motion model of the current block based on three CPMVs of the 6-parameter affine motion model of the neighboring block.

7. The device of claim 1, wherein the device comprises a video decoder.

8. The device of claim 1, wherein the device comprises a video encoder.

9. The device of claim 1, further comprising a display configured to display decoded video data.

10. The device of claim 1, wherein the device comprises one or more of a camera, a computer, a mobile device, a broadcast receiver device, or a set-top box.

11. A method of coding video data, the method comprising:
responsive to determining to inherit affine motion information for a current block of video data located in a current virtual pipeline data unit (VPDU) from a neighboring block of video data located in a different VPDU, deriving the affine motion information for the current block from two motion vectors of the neighboring block of video data regardless of whether the neighboring block of video data is coded with a 4-parameter affine model or a 6-parameter affine model;
determining, based on the derived affine motion information for the current block of video data, a predictor block of video data; and
reconstructing the current block of video data based on the predictor block of video data.

12. The method of claim 11, wherein the affine motion information for the current block of video data comprises control point motion vectors (CPMVs).

13. The method of claim 11, wherein the neighboring block is coded with a 6-parameter affine model represented by three control point motion vectors (CPMVs) and is located in a different VPDU than the current block, and wherein deriving the affine motion information for the current comprises deriving a 6-parameter affine motion model of the current block based on two CPMVs of the 6-parameter affine motion model of the neighboring block.

14. The method of claim 11, wherein the neighboring block is coded with a 6-parameter affine model represented by three control point motion vectors (CPMVs) and is located in a different VPDU than the current block, and wherein deriving the affine motion information for the current comprises deriving a 4-parameter affine motion model of the current block based on two CPMVs of the 6-parameter affine motion model of the neighboring block.

15. The method of claim 11, wherein the neighboring block is coded with a 6-parameter affine model represented by three control point motion vectors (CPMVs) and is located in a same VPDU as the current block, and wherein deriving the affine motion information for the current comprises deriving a 6-parameter affine motion model of the current block based on three CPMVs of the 6-parameter affine motion model of the neighboring block.

16. The method of claim 11, wherein the neighboring block is coded with a 6-parameter affine model represented by three control point motion vectors (CPMVs) and is located in a same VPDU as the current block, and wherein deriving the affine motion information for the current comprises deriving a 6-parameter affine motion model of the current block based on three CPMVs of the 6-parameter affine motion model of the neighboring block.

17. The method of claim 11, wherein coding comprises decoding.

18. The method of claim 11, wherein coding comprises encoding.

19. A computer-readable storage medium having stored thereon instructions that, when executed, cause one or more processors to:
derive, responsive to determining to inherit affine motion information for a current block of video data located in a current virtual pipeline data unit (VPDU) from a neighboring block of video data located in a different VPDU, the affine motion information for the current block from two motion vectors of the neighboring block of video data regardless of whether the neighboring block of video data is coded with a 4-parameter affine model or a 6-parameter affine model;
determine, based on the derived affine motion information for the current block of video data, a predictor block of video data; and
reconstruct the current block of video data based on the predictor block of video data.

20. The computer-readable storage medium of claim 19, further storing instructions that cause the one or more processors to:
retain, after coding the different VPDU that includes the neighboring block of video data, only a subset of the affine motion information of the neighboring block of video data.
